(19) United States
(12) Patent Application Publication
(10) Pub. No.: US 2025/0035750 A1
(43) Pub. Date: Jan. 30, 2025

(54) SYSTEMS, METHODS, AND MEDIA FOR SINGLE PHOTON DEPTH IMAGING WITH IMPROVED EFFICIENCY USING LEARNED COMPRESSIVE REPRESENTATIONS

(71) Applicant: Wisconsin Alumni Research Foundation, Madison, WI (US)

(72) Inventors: Felipe Gutierrez Barragan, Madison, WI (US); Andreas Velten, Madison, WI (US); Fangzhou Mu, Madison, WI (US); Yin Li, Madison, WI (US); Mohit Gupta, Madison, WI (US); Atul Ingle, Portland, OR (US)

(21) Appl. No.: 18/787,781

(22) Filed: Jul. 29, 2024

Related U.S. Application Data
(60) Provisional application No. 63/516,137, filed on Jul. 27, 2023.

(51) Int. Cl. G01S 7/48; G01S 7/4863; G01S 17/42; G01S 17/89; G06T 7/50

(52) U.S. Cl. CPC G01S 7/4808; G01S 7/4863; G01S 17/42; G01S 17/89; G06T 7/50; G06T 2207/10028; G06T 2207/20072; G06T 2207/20081; G06T 2207/20084

(57) ABSTRACT

In accordance with some embodiments, various examples of systems, methods, and media for single photon depth imaging with improved efficiency using learned compressive representations are provided. For example, systems and methods herein may detect a photon arrival based on a signal from a detector at a given position and time bin. A compressed histogram comprising K stored values, representing bins of the compressed histogram based on K values in a code word calculated based on the time bin and position and K coding tensors. Such systems and methods may be utilized for, among other uses, determining depth in a scene being imaged by the detector.

### CROSS-REFERENCE TO RELATED APPLICATIONS

The present application is based on, claims priority to, and incorporates herein by reference in its entirety for all purposes, U.S. Provisional Patent Application Ser. No. 63/516,137, filed Jul. 27, 2023.

### STATEMENT REGARDING FEDERALLY SPONSORED RESEARCH

This invention was made with government support under 1846884, 1943149 and 2138471 awarded by the National Science Foundation and under DE-NA0003921 awarded by the US Department of Energy. The government has certain rights in the invention.

### BACKGROUND

Detectors that can detect the arrival time of an individual photon, such as single-photon avalanche diodes (SPADs), can facilitate active vision applications in which a light source is used to interrogate a scene. For example, such single-photon detectors have proposed for use with fluorescence lifetime-imaging microscopy (FLIM), non-line-of-sight (NLOS) imaging, transient imaging, LiDAR systems, and other depth imaging systems. The combination of high sensitivity and high timing resolution has the potential to improve performance of such systems in demanding imaging scenarios, such as in systems having a limited power budget. For example, single-photon detectors can play a role in realizing effective long-range LiDAR for automotive applications (e.g., as sensors for autonomous vehicles) in which a power budget is limited and/or in which a signal strength of the light source is limited due to safety concerns.

Three-dimensional imaging systems (e.g., cameras) based on SPAD technology are becoming increasingly popular for a wide range of applications that require high-resolution and low-power depth sensing, ranging from autonomous vehicles to consumer smartphones. Kilopixel to megapixel resolution SPAD pixel arrays that are being developed will have the capability of capturing the time-of-arrival of billions of individual photons per frame with extremely high (picosecond) time resolution. However, this extreme sensitivity and high speed comes at a cost, as the raw timestamp data causes a severe bottleneck between the image sensor and an image signal processor (ISP) that processes this data (e.g., as described below in connection with FIG. 1, panel (a)). This data bottleneck severely limits the wider use of high-resolution SPAD arrays in 3D sensing, and other, applications.

One approach that has been developed to avoid transferring individual photon timestamps is to build a histogram in each pixel. This results in a 3D histogram tensor that is transferred off-sensor for processing. Although this may be practical at low spatio-temporal resolutions (e.g., 64×32 pixels with 16 time bins), it requires higher in-sensor memory. Additionally, the data rates of this histogram tensor representation also scale rapidly with the spatio-temporal resolution and maximum depth range (or other time bins) of the sensor. For example, a megapixel SPAD-based 3D camera operating at 30 frames per second (fps) that outputs a histogram tensor with a thousand 8-bit bins per pixel would require a data transfer rate of 240 gigabits pers second (Gbps).

FIG. 1 shows an example of a SPAD-based pulsed LiDAR system (sometimes referred to by other names such as Geiger-mode LiDAR and Single Photon LiDAR). The example shown in FIG. 1 includes a laser configured to send out light pulses periodically, and a SPAD that records the arrival time of the first detected photon in each laser period. Note that the first detected photon is not necessarily the first photon that is incident on the SPAD, as some photons that are incident will not be detected (the proportion of incident photons detected is sometimes referred to as the quantum efficiency of the detector), and some detections result from noise rather than an incident photon.

In such systems, the first photon detection times in each laser cycle can be collected and used to generate a histogram of the time-of-arrival of the photons that represents the distribution of detections. For example, as described below in connection with FIG. 2, a histogram representing arrival times of photons can be generated. If the incident flux level is within an acceptable range, the histogram can be expected to approximate a scaled version of the received temporal waveform of the reflected laser pulses. In such circumstances, the counts represented by the histogram can be used to estimate scene depths and reflectivity based on the location and height of a local maxima in the data represented by the histogram.

As described above, SPAD-based systems can generate very large amounts of data. For example, consider a megapixel SPAD-based 3D camera. For short range indoor applications (e.g., up to tens of meters), a millimeter depth resolution would be desirable. For longer range outdoor applications (e.g., hundreds of meters), centimeter level depth resolution would be desirable. Assuming state-of-the-art sub-bin processing techniques, this corresponds to histograms with thousands of bins per pixel, which would require reading out thousands of values per pixel in order to generate a depth for each pixel. Additionally, the rate at which such histograms can be generated can vary from tens of fps for low speed applications (e.g., land surveying) to hundreds of fps for high speed applications (e.g., an automotive application where objects may be moving at high speeds). Even a conservative estimate of a 30 fps megapixel camera leads to a large data rate (e.g., 10⁶ pixels/frame×1000 bins/pixel×2 bytes/bin×30 fps=60 GB/sec).

Coarse in-pixel histogramming has been proposed to reduce data rates in SPAD-based 3D cameras. Despite the low time resolution in coarse histograms, it is possible to achieve relatively high depth resolution by using wide pulses, pulse dithering, or with coarse-to-fine histogram architectures. However, as described below, coarse histogramming is a sub-optimal strategy.

Accordingly, systems, methods, and media for single photon depth imaging with improved efficiency using learned compressive representations are desirable.

### SUMMARY

In accordance with some embodiments of the disclosed subject matter, systems, methods, and media for single photon depth imaging with improved efficiency using learned compressive representations are provided.

In some aspects, the present disclosure can provide a system for determining a depth in a scene. The system can include a light source and an array including a plurality of detectors. The plurality detectors can detect arrival of individual photons. At least one processor can be programmed to detect a photon arrival based on a signal from a detector of the plurality of detectors. The detector of the plurality of detectors can have a position p′. The processor can be programmed to determine a time bin i associated with the photon arrival. The time bin can be in a range from 1 to Nₜ where Nₜ is a total number of time bins. The processor can be programmed to update a compressed histogram with K stored values representing bins of the compressed histogram based on K values in a code word calculated based on the time bin i and the position p′ and K coding tensors. Each coding tensor of the K coding tensors can be different than each other coding tensor. The processor can be programmed to perform an imaging task based on the K values of the compressed histogram.

In some aspects, the present disclosure can provide a method for determining a depth in a scene. A photon arrival can be detected based on a signal from a detector of a plurality of detectors. The detector of the plurality of detectors can have a position p′. A time bin i can be determined. The time bin i can be associated with the photon arrival. The time bin can be in a range from 1 to Nₜ where Nₜ is a total number of time bins. A compressed histogram can be updated. The compressed histogram can include K stored values representing bins of the compressed histogram based on K values in a code word calculated based on the time bin i and the position p′ and K code tensors. Each coding tensor of K code tensors can be different than each other coding tensor. An imaging tasks can be performed based on the K values of the compressed histogram.

In some aspects, the present disclosure can provide a system for generating compressed single-photon histograms. The system can include a light source and an array including a plurality of detectors. The plurality of detectors can detect arrival of individual photons. At least one processor can be programmed to detect a photon arrival based on a signal from a detector of the plurality of detectors. The detector of the plurality of detectors can have a position p′. The at least one processor can be programmed to determine a time bin i associated with the photon arrival. The time bin can be in a range from 1 to Nₜ where Nₜ is a total number of time bins. The at least one processor can be programmed to update a compressed histogram including K stored values representing bins of the compressed histogram based on K values in a code word calculated based on the time bin i and the position p′ and K coding tensors. Each coding tensor of the K coding tensors can be different than each other. The at least one processor can be programmed to output the compressed histogram to another processor.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a single photon avalanche diode (SPAD)-based pulsed LiDAR system.

FIG. 2 shows an example of a histogram representing arrival times of photons in a series of cycles.

FIG. 3 shows an example illustrating a data bottleneck in a conventional single-photon imaging system, and a single-photon imaging system implemented in accordance with some embodiments of the disclosed embodiments.

FIG. 4 shows an example of a flow for compressing single-photon data using a compressive representation in accordance with some embodiments of the disclosed embodiments.

FIG. 5A shows an example of a flow for generating compressive histograms that represent single-photon data collected over a period of time in accordance with some embodiments of the disclosed embodiments.

FIG. 5B shows an example of a flow for decoding compressive histograms that represent single-photon data collected over a period of time in accordance with some embodiments of the disclosed embodiments.

FIG. 6 shows an example of a system for single photon depth imaging with improved efficiency using learned compressive representations in accordance with some embodiments of the disclosed subject matter.

FIG. 7 shows an example of a process for improving the efficiency of transferring data from a single-photon image sensor in accordance with some embodiments of the disclosed subject matter.

FIG. 8A shows an example of compression ratio and mean absolute depth errors computed over a test set for various techniques for estimating depth in a single photon depth imaging system.

FIG. 8B shows an example of compression ratio and a percent number of pixels with errors computed over a test set for various techniques for estimating depth in a single photon depth imaging system.

FIG. 9 shows examples of depth reconstructions generated using compressed histograms generating using various techniques including manually designed coding tensors, randomly initialized coding tensors, and learned coding tensors in accordance with some embodiments of the disclosed subject matter.

FIG. 10 shows examples of depth reconstructions generated from single-photon data compressed using various techniques, including on-chip depth calculation, and learned coding tensors in accordance with some embodiments of the disclosed subject matter.

FIG. 11 shows examples of depth reconstructions generated from single-photon data compressed using different spatial block sizes of learned coding tensors in accordance with some embodiments of the disclosed subject matter at a fixed compression ratio, and associated mean average error.

FIG. 12 shows examples of depth reconstructions generated from single-photon data compressed using different spatial block sizes of learned coding tensors in accordance with some embodiments of the disclosed subject matter at a higher fixed compression ratio, and associated mean average error.

FIG. 13 shows examples of temporal dimensions of compression in accordance with some embodiments of the disclosed subject matter.

FIG. 14 shows a comparison between compression and test set metrics on large depths test set.

FIGS. 15A and 15B show example depth reconstructions at 32× and 128× compression for scenes, respectively.

FIG. 16 shows an effect of spatial tensor dimension.

FIG. 17 shows an effect of another spatial tensor dimension.

FIG. 18 shows the quantitative and qualitative performance of different learned coding tensors at 32× compression and 128× compression.

FIGS. 19 and 20 show the quantitative and qualitative performance of different learned coding tensors at 32× compression and 128× compression, respectively.

FIG. 21 shows a temporal dimension of 64× compression.

FIGS. 22 and 23 show the overall test set performance and qualitative depth reconstructions for multiple compressive histogram models at 64× and 128× compression, respectively.

FIG. 24 shows the depth reconstructions for the oracle baselines and multiple compressive histograms at 128× compression.

FIG. 25 shows the expected compression ratios for different histogram tensor and coding tensor sizes.

FIG. 26 shows the expected compression ratios for different histogram tensor and coding tensor sizes for a separable coding tensor that is 16× smaller than a full coding tensor.

### DETAILED DESCRIPTION

In accordance with various embodiments, mechanisms (which can, for example, include systems, methods, and media) for single photon depth imaging with improved efficiency using learned compressive representations are provided.

In some embodiments, mechanisms described herein can be used to generate compressive histograms that can improve the efficiency of single photon depth imaging systems, for example, by reducing the per-pixel output data rate at a particular depth resolution and frame rate.

Single-photon cameras (SPC) are an emerging sensor technology with ultra-high sensitivity down to individual photons. In addition to their extreme sensitivity, SPCs based on single-photon avalanche diodes (SPADs) can also record photon-arrival timestamps with extremely high (sub-nanosecond) time resolution. Moreover, SPAD-based SPCs are compatible with complementary metal-oxide semiconductor (CMOS) photolithography processes which can facilitate fabrication of kilo-to-mega-pixel resolution SPAD arrays at relatively low costs. Due to these characteristics, SPAD-based SPCs are gaining popularity in various imaging applications including 3D imaging, passive low-light imaging, HDR imaging, non-line-of-sight (NLOS) imaging, fluorescence lifetime imaging (FLIM) microscopy, and diffuse optical tomography.

Unlike a conventional camera pixel that outputs a single intensity value integrated over micro-to-millisecond timescales, a SPAD pixel generates an electrical pulse for each photon detection event. A time-to-digital conversion circuit converts each pulse into a timestamp recording the time-of-arrival of each photon. Under normal illumination conditions, a SPAD pixel can generate millions of photon timestamps per second. The photon timestamps are often captured with respect to a periodic synchronization signal generated by a pulsed laser source. To make this large volume of timestamp data more manageable, SPAD-based SPCs can build a timing histogram on-chip instead of transferring the raw photon timestamps to the host computer. The histogram can record the number of photons as a function of the time delay with respect to the synchronization pulse.

In some embodiments, mechanisms described herein can be used to implement bandwidth-efficient acquisition strategies using coding tensors which can be used to encode a block of a 3D histogram tensor into a single compressive histogram. In some embodiments, rather than capturing the full timing histogram in each pixel, compressive histograms can be constructed by mapping the time bins of the histograms for multiple pixels onto multiple a compressive histogram though an encoding process.

As described below, in some embodiments, mechanisms described herein can utilize a family of compressive encoders that can be represented as a series of simple matrix operation. Such compressive encoders can be implemented efficiently using operations equivalent to multiply-add operations that can be computed on-the-fly (e.g., as each photon arrives), without the need to store large arrays of photon timestamps on-chip. In some embodiments, using mechanisms described herein can decouple the dependence of output data rate on the desired depth resolution. For example, while a full histogram requires more time bins to achieve higher depth resolution, compressive histograms generated using mechanisms described herein can represent a higher depth resolution using a similar (e.g., almost the same) number, or lower number, of data points.

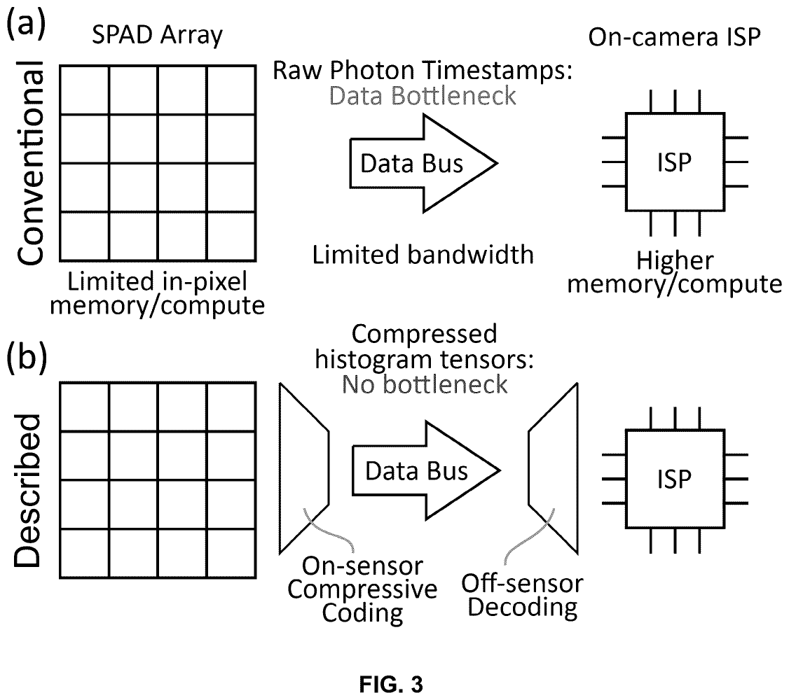

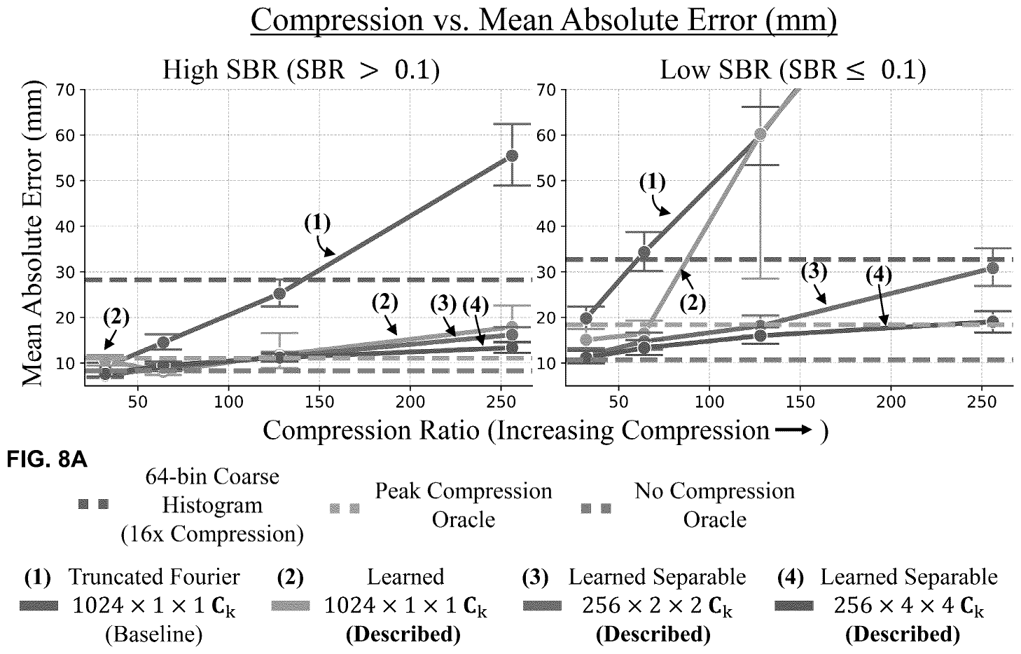

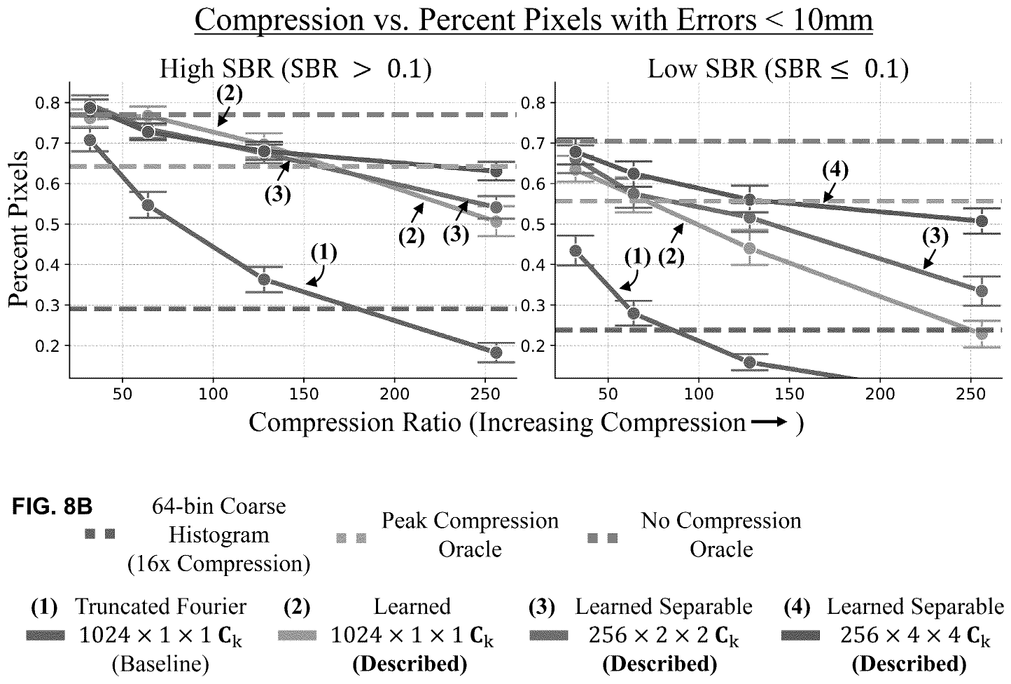

As described below in connection with FIG. 3, SPCs (e.g., SPAD-based 3D cameras) encounter a data bottleneck between the image sensor array (e.g., SPAD array) and the compute module (e.g., a hardware processor) when transferring the photon timestamps. A histogram tensor can help summarize timestamps at low resolutions, but as megapixel SPAD arrays become available, histogram tensors also lead to a data bottleneck. In some embodiments, mechanisms described herein can be used to generate compressive histograms as a compact representation that can be built on-the-fly, as each photon is detected, which can mitigate the data bottleneck between the image sensor and compute module. In some embodiments, compressive histograms generated using mechanisms described herein can reduce in-sensor memory and data rates, as neither the photon data stream nor a histogram tensor needs to be explicitly stored or transferred. Results described below (e.g., in connection with FIGS. 8A to 13) show that high-quality depth information can be recovered from a compressive histogram representation (e.g., generated using learned coding tensors) that is up to two orders of magnitude smaller than a histogram tensor representation.

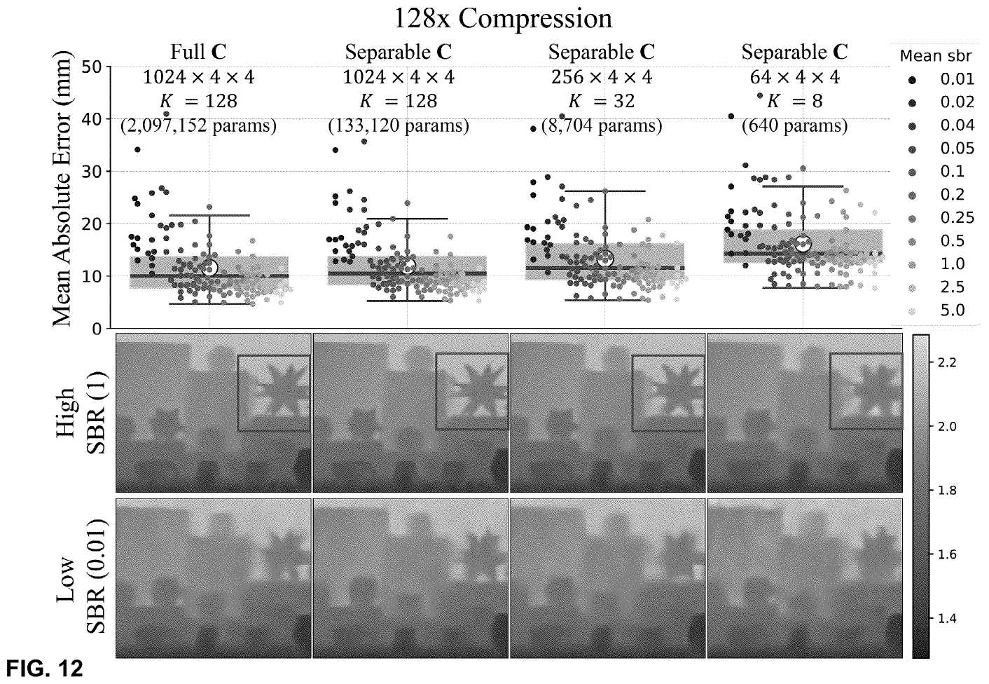

For a fixed compression level, as noise increases (e.g., as signal to background ratio (SBR) decreases) reconstruction quality degrades. In results described below, degradation in image quality first results in the loss of fine details and subsequently the loss of coarser higher-level scene information. By increasing the size of coding tensors, reconstruction quality can be recovered up to a certain degree (e.g., as described below in connection with FIG. 12). Additionally, reducing the compression ratio is also an effective technique to recover this scene information.

As described in herein coding tensors with Mₜ=Nₜ can develop a depth range bias. For example, these coding tensors can learn to zero out photons coming from distances that are less common in the dataset since they are usually background/noise photons. Interestingly, learned coding tensors with Mₜ<Nₜ avoid this bias and generalize to depths that are less common in the training set.

While SPAD-based 3D cameras with large in-pixel memory could potentially store per-pixel histograms and reduce data rates by computing depths in-pixel (sometimes referred to herein as a peak compression oracle), results described below show that compressive histograms can provide similar reconstruction quality and outperform this technique at low SBR without requiring the storage of the full histogram tensor in-sensor.

Note that although promising empirical results are shown for the coding tensor representations described herein, an optimal set of coding tensors depends on the hardware specifications (e.g, in-pixel memory, system bandwidth) and scene-dependent parameters (e.g., SBR, geometry, albedo). Additional lightweight coding tensors can be implemented using mechanisms described herein that rely on other factorization techniques and weight quantization.

Note that histogram tensors are used in various active single-photon imaging modalities, in addition to depth sensing, such as fluorescence lifetime microscopy (FLIM), non-line-of-sight, and diffuse optical tomography. In some embodiments, mechanisms described herein can be used to find compressive representations suitable for these additional applications.

As described below, while coarse histogramming can be considered a form of compressive histogram, coarse histogramming is sub-optimal compared to other compressive histogramming strategies. Other data reduction strategies, such as motion-driven operation or multi-photon triggering have been proposed to reduce the amount of data generated by SPADs. Additionally, in the context of scanning-based systems, adaptive sampling techniques have been proposed to reduce sampling rates and consequently data transfers. In some embodiments, such techniques can be used in a complementary manner with mechanisms described herein to further reduce data rates.

Recently, Fourier-domain histograms (FDHs) were proposed for fast non-line-of-sight (NLOS) imaging and for single-photon 3D imaging. FDHs can be generated using mechanisms described herein as one type of compressive histogram that can achieve significant compression over regular histogramming. However, strategies described below can be used to implement coding tensors that are more efficient than FDH for 3D imaging, and that are also more robust to diffuse indirect reflections commonly found in flash illumination systems are described below.

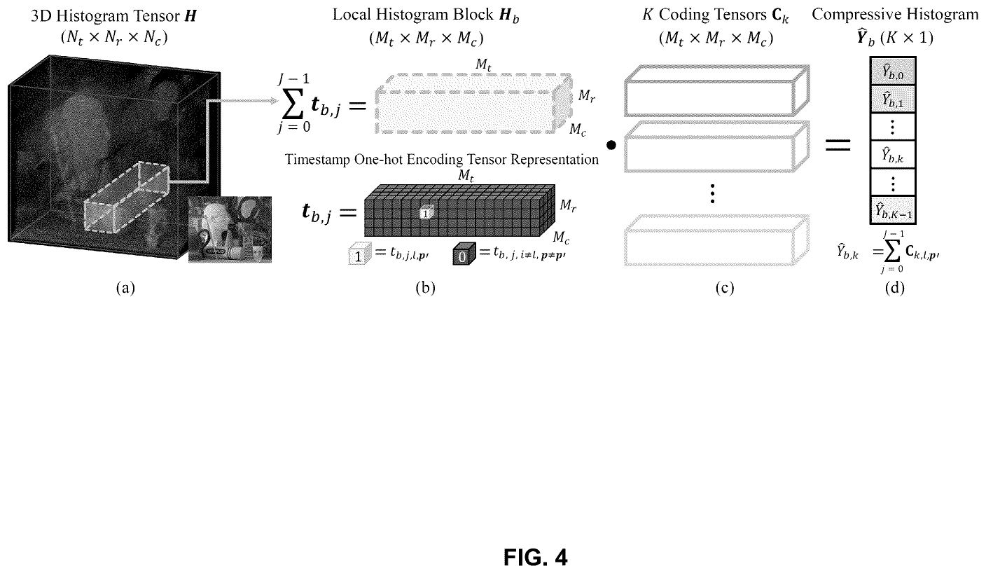

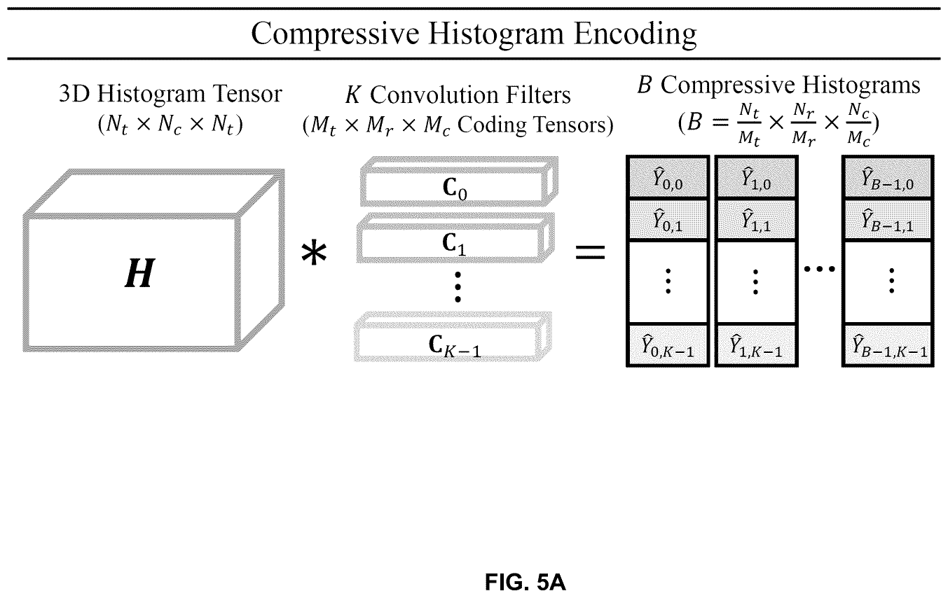

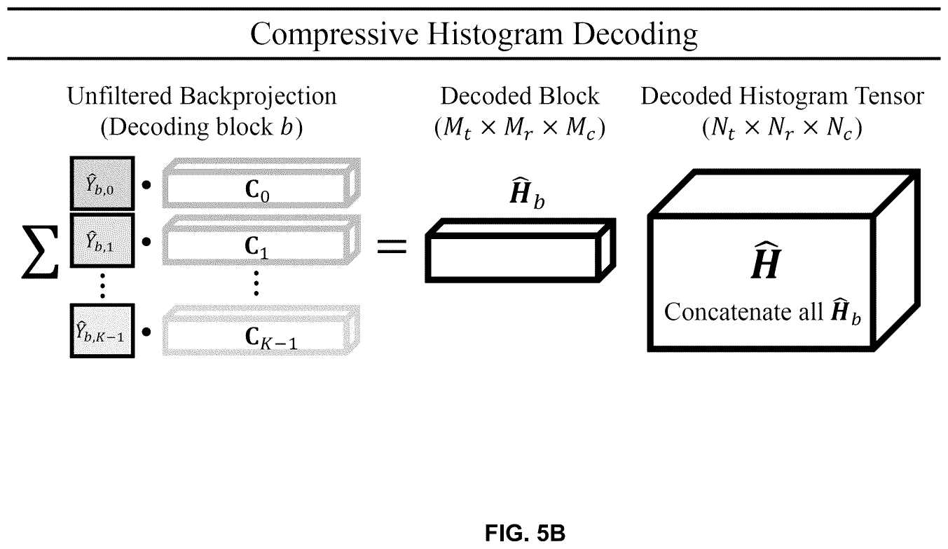

In some embodiments, mechanisms described herein can use a set of coding tensors (e.g., K matrices that are each Mₜ×Mᵣ×M_{c} described below in connection with FIGS. 4, 5A, and 5B, or a K×Mₜ×Mᵣ×M_{c} matrix) to generate a compressive histogram that represents a block of the 3D histogram tensor (e.g., of size Mₜ×Mᵣ×M_{c}) as a compressed representation of a full-resolution histogram for a single-photon detector that can be used to determine a time of flight of a light pulse emitted from a co-located source. For example, each coding tensor can correspond to a code word having Mₜ×Mᵣ×M_{c} elements (e.g., each element within a predetermined range, such as from −1 to 1) that are added to the compressed histogram. At the end of a frame, the values of the compressed histogram can be read out, decoded, and used to determine a depth (or other value) for scene points corresponding to the single-photon detectors used to generate the compressed histogram (e.g., using EQ. (6), described below).

Compressive histograms, sometimes referred to as sketches, are an emerging framework for online in-sensor compression of SPAD timestamp data. A coarse histogram is one common compressive histogram approach to reduce data rates and in-pixel memory. Despite their practical hardware implementation, coarse histograms achieve sub-optimal depth accuracy compared to compressive histograms based on Fourier and Gray codes. One limitation of these approaches is that the compressive representation only exploits the temporal information of the incident timestamp, and disregards the spatial redundancy. As described herein, mechanisms described herein can generalize the compressive histogram framework to utilize spatio-temporal information of each timestamp. Additionally, instead of relying on hand-designed coded projections, mechanisms described herein can be used to learn coding tensors as a layer (e.g., a first layer) of a convolutional neural network (CNN).

In some embodiments, multiple neighboring single-photon detectors (e.g., SPAD pixels) can utilize a single shared memory where all timestamps are aggregated into a coarse histogram (e.g., a 4×4 block of pixels, a 3×3 block of pixels, etc.). Such techniques can discard local spatial information (e.g., precise pixel location) of the detected photon timestamps. Compressive histograms implemented using mechanisms described herein are well-suited for such a shared memory implemented, as a compressive histogram can be shared among multiple SPAD pixels and can preserve spatial information through the coded projection. For example, when a timestamp is detected at a pixel, K values are identified from the coding tensor, and those K values are aggregated to the compressive histogram. The K value from the coding tensor can encode spatial and temporal information, which help preserve the spatial information. If the timestamp is only aggregated on a regular histogram, the spatial information is discarded.

Pixel processor arrays (PPAs) are an emerging sensing technology that embeds processing electronics inside each pixel. This sensing paradigm begins processing the image at the focal plane array, which allows it to reduce the sensor data rates by transmitting only the relevant information, and consequently, can increase sensor throughput which can facilitate computer vision at 3,000 fps. PPAs have also become building blocks of novel computational imaging systems optimized end-to-end for HDR imaging, motion deblurring, video compressive sensing, and light field imaging. In some embodiments, compressive histograms implemented using mechanisms described herein can utilize in-pixel processing techniques. For example, mechanisms described herein can optimize sensor parameters (e.g., values of coding tensors used to generate compressive histograms) and a processing algorithm (e.g., a CNN) to compress data generated by an array of single-photon detectors.

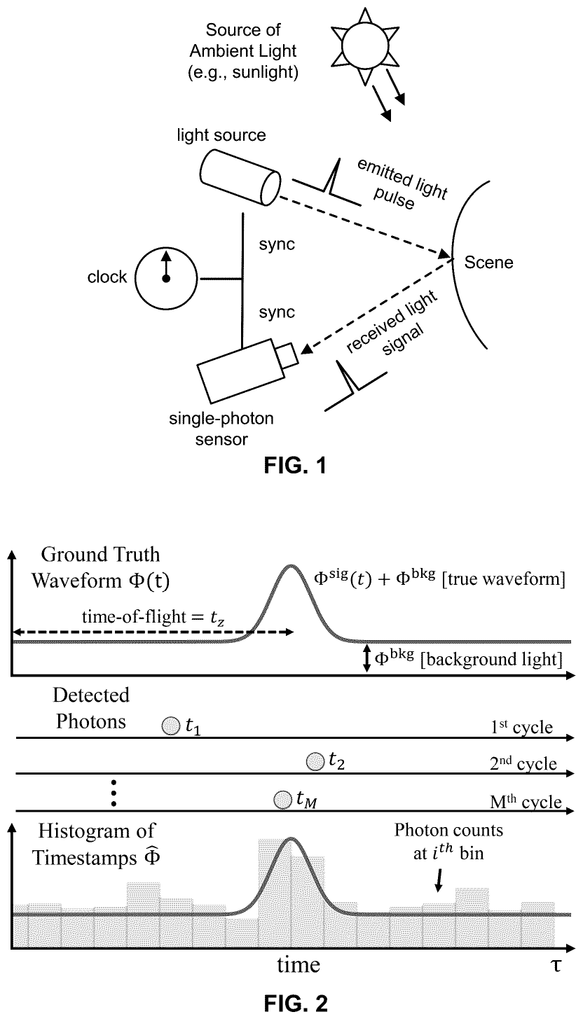

FIG. 1 shows an example of a SPAD-based pulsed imaging system (e.g., a LiDAR system, sometimes referred to by other names such as Geiger-mode LiDAR and Single Photon LiDAR, a single photon 3D camera). The example shown in FIG. 1 includes a light source (e.g., a laser) configured to send out light pulses periodically, and a SPAD that records the arrival time of the first detected photon in each laser period, after which it enters a dead time, during which the SPAD is inhibited from detecting any further photons. Note that the first detected photon is not necessarily the first photon that is incident on the SPAD, as some photons that are incident will not be detected (the proportion of incident photons detected is sometimes referred to as the quantum efficiency of the detector), and some detections result from noise rather than an incident photon.

In such systems, the first photon detection times in each laser cycle can be collected and used to generate a histogram of the time-of-arrival of the photons that represents the distribution of detections. For example, FIG. 2 shows a histogram representing arrival times of photons in a series of cycles. If the incident flux level is sufficiently low, the histogram can be expected to approximate a scaled version of the received temporal waveform of the reflected laser pulses. In such circumstances, the counts represented by the histogram can be used to estimate scene depths and reflectivity based on the location and height of a local maxima in the data represented by the histogram. A SPAD-based 3D camera can estimate distances by building a per-pixel histogram of the detected photons time-of-arrival. The histogram is a discrete approximation of the photon flux waveform incident on the pixel, which encodes distances in the time shift (t_{z}) of the pulse.

In a SPAD-based 3D camera, the SPAD-based camera can include a SPAD sensor and a pulsed laser that illuminates the scene. The photon flux signal arriving at pixel, p, can be expressed as:

$${Φ}_{p} ( t ) = {a}_{p} h ( t - 2 {d}_{p} / c ) + {Φ}_{p}^{bkg} = {Φ}_{p}^{sig} ( t ) + {Φ}_{p}^{bkg} , \qquad ( 1 )$$

where aₚ is the amplitude of the returning signal accounting for laser power, reflectivity, and light fall-off; h (t) is the system's impulse response function (IRF) which accounts for pulse waveform and sensor IRF; dₚ is the distance to the point imaged by point p; c is the speed of light; and Φₚ^{bkg} is the constant photon flux due to background illumination (e.g., sunlight, indoor lighting, etc.). This model assumes direct-only reflections which is generally a valid approximation, in particular, for scanning-based ToF 3D imaging systems.

Time-correlated single photon counting (TCSPC)-based SPAD cameras can measure (t) by building a per-pixel timing histogram (e.g., as shown in FIG. 2), where the i^{th} histogram bin records the number of photons that arrived in a time interval of length Δ, which follows a Poisson process [symbol] :

$${Φ}_{i , p} = 𝒫 ( {Φ}_{i , p}^{sig} , + {Φ}_{p}^{bkg} ) . \qquad ( 2 )$$

A pulse repetition period, τ, can determine the maximum timestamp value and the length of a histogram vector Φₚ=(Φ_{i,p})ᵢ₌₀^{N}^{ₜ}⁻¹, where Nₜ=τ/Δ. Therefore, one assumption built into Φₚ, is that no signal photons had a timestamp larger than τ, which means that the maximum distance that Φₚ can encode is

$${d}_{max} = \frac{c τ}{2} .$$

Additionally, it can be assumed that pile-up distortions are minimized through various SPAD data acquisition techniques. For example, it can be assumed that the SPAD sensor is being operated in asynchronous mode or is capable of multi-event timestamp collection, which can mitigate pile-up distortions, and can guarantee that Φ_{i,p} is an appropriate approximation of Φₚ(t). As shown in FIG. 2, the above process can be repeated for M cycles, and a histogram of the timestamps can be constructed which approximates Φₚ(t)

This process can generate a Nₜ×Nᵣ×N_{c} 3D histogram tensor, H=(Φ_{i,p})_{p=(0,0)}^{(N}^{ᵣ}^{-1,N}^{_{c}}⁻¹⁾. In challenging 3D imaging scenarios (e.g., with high background illumination), building H off-sensor typically requires transferring thousands of photon timestamps per-pixel, which can lead to data rates of hundreds of GB/s in a megapixel sensor. Additionally, building and storing a high-resolution H in-sensor would require significant memory (e.g., at least 1 GB for a megapixel SPAD camera with 1000 time bins per-pixel), and transferring H from the in-sensor memory would continue to lead to impractical data rates of at least tens of GB/s on a SPAD-based 3D camera operating at 30 fps. In some embodiments, mechanisms described herein can be used to implement a practical SPAD-based 3D camera that builds and stores a compact representation of H in-sensor, and transfers the compact representation to a processing chip (e.g., a field-programmable gate array (FPGA), an image signal processor (ISP), an embedded computer) where H is processed.

FIG. 3 shows an example illustrating a data bottleneck in a conventional single-photon imaging system, and a single-photon imaging system implemented in accordance with some embodiments of the disclosed embodiments.

FIG. 3, panel (a), shows a conventional SPAD-based 3D cameras are configured to stream raw photon timestamps or summary histograms off the image sensor which causes a data bottleneck between the image sensor and the on-camera ISP. FIG. 3, panel (b), shows an example in which a lightweight, on-sensor compressive coding scheme implemented in accordance with some embodiments of the disclosed subject matter to the photon timestamp data which can be decoded at the ISP, mitigating the data bandwidth limitation.

In some embodiments, mechanisms described herein can be used to generate compressive representations of 3D histogram tensors. In order to reduce the data rates output by the SPAD camera, the compact representation can be built in-pixel or inside the focal plane array (FPA) (e.g., as shown in FIG. 3, panel (b)). Due to the limited in-pixel memory and compute, a compressive representation implemented in accordance with mechanisms described herein can be built in a streaming manner, with minimal computations per photon. As photon histogram tensors are very different from conventional RGB images and video data, conventional compression algorithms (e.g., JPEG, MPEG, etc.) are not directly applicable, and often require the entire data set (e.g., cannot be built in a streaming manner).

In some embodiments, mechanisms described herein can be used to implement a family of compressive representations for 3D histogram tensors that can be computed in an online fashion with limited memory and compute. Compressive representations implemented in accordance with mechanisms described herein can be based on the linear spatio-temporal projection of each photon timestamp, which can be expressed as a simple matrix operation. Instead of constructing per-pixel timestamp histograms, a compressive encoding implemented in accordance with mechanisms described herein can map its spatio-temporal information into a compressive histogram. To exploit local spatio-temporal correlations, a single compressive histogram can be built for a local 3D histogram block (e.g., as described below in connection with FIG. 4). Instead of building and storing the full 3D histogram tensor in-sensor, multiple compressive histograms can be built and transferred off-sensor for processing, effectively reducing the required in-sensor memory and data rates (e.g., holding the size of the detector array constant).

In some embodiments, mechanisms described herein can be used to integrate a compression framework with data-driven single-photon data processing techniques (e.g., using convolutional neural networks (CNNs)), which can facilitate end-to-end optimization of the compressive encoding and a single-photon data (e.g., SPAD data) processing CNN.

As described below in connection with FIGS. 8A to 13, experimental results were generated in which a compressive histograms framework implemented in accordance with some embodiments of the disclosed subject matter is integrated with a state-of-the-art learning-based denoising model for SPAD-based 3D imaging. The results show that the jointly optimized compressive encoding and CNN can consistently reduce data rates up to 2 orders of magnitude in a wide range of signal and noise levels. Additionally, for a given compression level, it can increase 3D imaging accuracy over previous hand-designed compressive histograms that only exploit temporal information, especially in low signal-to-background ratio (SBR) scenarios and at higher compression rates. Further, the results show that learned compressive histograms can perform comparably and sometimes even outperform a theoretical SPAD sensor design where the full 3D histogram tensor is stored in-sensor and only per-pixel depths are transferred off-sensor (which requires prohibitive amounts of in-sensor memory and compute, as described above).

FIG. 4 shows an example of a flow for compressing single-photon data using a compressive representation in accordance with some embodiments of the disclosed embodiments. As shown in FIG. 4, histogram tensors, H, can be a 3D spatio-temporal grid with elements that store the number of photons that arrived within a relatively short time interval. As shown in FIG. 4, panel (a), in SPAD-based 3D imaging, the temporal axis of H can encode distances, as the time bin at which a photon is detected can correspond to a particular time-of-flight. FIG. 4, panel (b), shows a histogram block, H_{b}, which can be expressed as the sum of J one-hot encoding tensors, where each tensor represents a photon timestamp. In FIG. 4, panel (c) a compact representation of H_{b} can be built by applying K linear projections (e.g., dot products) with pre-defined coding tensors, which can generate a compressive histogram that represents the information in block H_{b}, as shown in FIG. 4, panel (d), which can be a vector with K elements whose compression capacity can be represented as Mₜ·Mᵣ·M_{c}/K.

A natural approach to compress H that exploits its local correlations due to smooth depths and photon flux, is to build a compressive representation of a local 3D histogram block as illustrated in FIG. 4. To avoid storing or transferring the photon timestamp stream, the compressive representation can be built as each timestamp arrives. As described below, mechanisms described herein can be used to implement an online compression framework for histogram blocks based on the coded projection of photon timestamps. Such an online compression framework can operate in a streaming manner as photons are detected (e.g., rather than requiring all photon detections in a frame to have already occurred).

A histogram H_{b} can be defined as a b^{th} histogram block of H with dimensions Mₜ×Mᵣ×M_{c}, where Mₜ≤Nₜ, Mᵣ≤N_{c}, and M_{c}≤N_{c}. It can be observed that H_{b} can be expressed as the sum of J one-hot encoding tensors, each representing one photon detection within H_{b} (e.g., as shown in FIG. 4, panel (b)). Specifically, t_{b,j} can be a Mₜ×Mᵣ×M_{c} one-hot encoding tensor representing the j^{th} photon timestamp detected in histogram block H_{b}, whose elements are all 0 except for t_{b,j,l,p′}=1, where

$$l = ⌊ \frac{{T}_{j} mod ( Δ {M}_{t} )}{Δ} ⌋ ,$$

Tⱼ is the timestamp value, and p′ is the pixel where the timestamps was detected. Using this representation H_{b} can be represented as follows:

$${H}_{b} = {\sum }_{j = 0}^{J - 1} {t}_{b , j} . \qquad ( 3 )$$

In some embodiments, H_{b} can be compressed in an online fashion through the linear projection of each timestamp tensor. For example, expressed as an inner product with K pre-designed coding tensors, Cₖ, with dimensions Mₜ×Mᵣ×M_{c} (e.g., as shown in FIG. 4, panel (c)). This can be represented using the following relationship:

$${\hat{Y}}_{b , k} = {C}_{k} \cdot {H}_{b} = {\sum }_{j = 0}^{J - 1} {C}_{k} \cdot {t}_{b , j} = {\sum }_{j = 0}^{J - 1} {C}_{k , l , {p}^{′}} , \qquad ( 4 )$$

where · denotes element-wise multiplication, and l and p′ are indices where t_{b,j,l,p′}=1. Using this representation, Ŷ_{b}=(Ŷ_{b,k})ₖ₌₀^{K-1} can be defined as a compressive histogram of H_{b}. A special case of EQ. (4) is described in U.S. patent application Ser. No. 17/834,884, filed Jun. 7, 2022, which is hereby incorporated by reference herein in its entirety, where C compresses histograms associated with individual pixels, and disregards spatial information (e.g., Mₜ=Nₜ, Mᵣ=1, M_{c}=1). Note that each timestamp in EQ. (4) can be processed efficiently on-the-fly after each photon detection through a simple lookup operation. Additionally, individual histogram blocks and/or timestamps do not need to be explicitly stored or transferred off-sensor.

Compressive histograms, when implemented as in EQ. (4), can introduce an in-sensor memory overhead because, in addition to storing Ŷ_{b}, C needs to be stored in-sensor for efficient lookup operations. In some examples, C can be shared among multiple pixels. So if a block has a spatial dimension of 2×2, C can be shared among 2×2 pixels. Therefore, a given pixel would only have to store the row of C that is associated to it. In some embodiments, a practical compressive single-photon camera implemented using mechanisms described herein can rely on parameter-efficient coding tensors that mitigate such overhead. Note that two strategies to design practical coding tensors were evaluated, and results are described below in connection with FIGS. 8A to 13. However, these are merely examples, and other coding tensor implementations consistent with techniques described herein can be used to generate compressive histograms.

Certain coding tensor implementations may be impractical, as they may incur memory overhead that renders them unsuitable. Consider a set of coding tensors that operate on the full histogram tensor (e.g., H_{b}=H). In this case, the number of elements in C exceeds the number of elements of H. Consequently, although the data rates are reduced in this scenario since K<(Nₜ·Nᵣ·N_{c}), the in-sensor memory required exceeds the size of the histogram tensor. To mitigate this issue, two complementary strategies to implement lightweight coding tensors are described below: local block-based and separable.

Local Block-based Coding Tensors: As the size of the histogram block H_{b} represented by a compressive histogram is reduced, the size of the coding tensors also decreases. Therefore, compressing local histogram blocks not only offers benefits due to local spatio-temporal redundancies, but also can be beneficial because these local coding tensors have fewer parameters than larger coding tensors. For example, local block-based coding tensors are used in temporal compressive histograms described in U.S. patent application Ser. No. 17/834,884, which has been incorporated by reference herein, where H_{b} is a per-pixel histogram. Separable Coding Tensors: Another approach to implementing lightweight coding tensors that can be used is to make them separable along the temporal and spatial dimensions. This approach can be also be used in parameter-efficient CNN models that use separable depth-wise convolutional layers to reduce model size. A separable coding tensor can be represented as the outer product of two smaller tensors:

$${C}_{k} = {C}_{k}^{temporal} ⊗ {C}_{k}^{spatial} , \qquad ( 5 )$$

where Cₖ^{temporal} is a Mₜ×1×1 tensor, and Cₖ^{spatial} is a 1×Mᵣ×M_{c} tensor. In some examples, each k has a different temporal component. So, for every k, there can be one C^{temporal} and one C^{spatial}. This implementation can also be beneficial due to differences between the temporal and spatial correlations encountered in histogram blocks. In addition to local correlations present in both dimensions, the temporal dimension often exhibits long-range correlations due to the background illumination offset (Φₚ^{bkg}) in every histogram bin. Accordingly, EQ. (5) can be used to represent such correlations by encoding the temporal and spatial information independently.

One assumption made in the memory overhead analysis described herein is that a compressive SPAD-based 3D camera only needs to store a single C that is shared across the full sensor, which can be implemented in two general ways. One approach can distribute C across the local memory of all pixels and then allow communication across pixels (e.g., as in pixel processor arrays (PPAs)). Another approach can store C in a global memory that can be accessed by all pixels which can be facilitated using any suitable techniques, such as in 3D-stacked SPAD cameras. Additionally, some of the coding tensor implementations described herein have as few as 640 parameters. In such an example, even if C is stored for every 4×4 group of pixels, the in-sensor memory can still be reduced by 20× compared to storing a 1024 bin per-pixel histogram.

FIGS. 5A and 5B show examples flows for generating compressive histograms that represent single-photon data collected over a period of time, and decoding compressive histograms that represent the single-photon data in accordance with some embodiments of the disclosed embodiments.

FIG. 5A, shows techniques that can be used to build a compressive histogram for each block in the histogram tensor, which can be viewed as applying K strided convolutional filters with weights that are the coding tensors. The compressed histogram tensor can be K

$$\frac{{N}_{t}}{{M}_{t}} \times \frac{{N}_{r}}{{M}_{r}} \times \frac{{N}_{c}}{{M}_{c}}$$

tensors. FIG. 5B shows techniques that can be used to lift the compressed histogram tensor back to the original domain, for example, using an unfiltered backprojection operation, which can be applied on each compressive histogram, thereby decoding a single block of the histogram. In some embodiments, the decoded histogram tensor can be assembled by concatenating all the decoded blocks into the original position of the block within H.

In some embodiments, mechanisms described herein can build a compressive histogram for each histogram block H_{b}. Using a block size that is less than the size of H, multiple compressive histograms can be used to encode the complete histogram tensor H. In this way, the coding tensors can be viewed as a set of 3D convolutional filters, which can be implemented as a layer of a CNN (e.g., a first layer of a 3D CNN). For simplicity, it is assumed that histogram blocks do not overlap, with the stride of the convolutional filters being equal to their dimensions. However, in some examples, the systems and methods described herein may also be used when the histogram blocks overlap by accounting for the overlap using the compression ratio expression.

Note that the compressed histogram tensor representation is not directly compatible with 3D CNNs that have been designed for SPAD-based 3D imaging (e.g., as described in Peng et al., “Photon-efficient 3d imaging with a non-local neural network,” in European Conference on Computer Vision, pp. 225-241 (2020) and Lindell et al., “Single-photon 3d imaging with deep sensor fusion,” ACM Trans. Graph, 37 (4): 113-1 (2018)). In some embodiments, each compressive histogram can be lifted back to the original 3D domain through an unfiltered backprojection when used in connection with such a pre-trained CNN. For example, the following relationship can be used to decode the compressive histograms:

$${\hat{H}}_{b} = {\sum }_{k = 0}^{K - 1} {C}_{k} {\hat{Y}}_{b , k} . \qquad ( 6 )$$

where Ĥ_{b} is the decoded compressive histogram for block b, which is a weighted linear combination of the coding tensors. The decoded histogram blocks can be concatenated and given as input to a processing 3D CNN. FIG. 5B shows techniques for decoding. In some embodiments, decoding using EQ. (6) can be performed off-sensor, after the compressive histograms have been moved to a compute module which has access to larger memory and computational resources than the sensor module. A benefit of using unfiltered backprojection as the upsampling operator is that if all coding tensors are mutually orthogonal, in the limit when K approaches the size of H_{b} (e.g., no compression), then Ĥ_{b}≈H_{b}. This suggests that at compression rates close to unity, an appropriately trained compressive histogram layer can be approximately equal to an identity transformation applied to H_{b}.

In some embodiments, a compressive histogram layer can include an encoding/compression portion implemented on a single-photon detection chip, and a decoding/decompression portion and can be implemented off the single-photon detection chip (e.g., on a processor that receives the compressed histograms). This layer can be appended to the beginning of any CNN that has been designed to process 3D histogram tensors in any suitable application (e.g., depth estimation, FLIM, NLOS, etc.). Additionally, in some embodiments, at least a portion of the coding tensors can be jointly optimized with the downstream CNN in an end-to-end manner. In some examples, when the CNN is a three-dimensional CNN what was trained to process a three-dimensional histogram tensor, the decoding step in FIG. 5B can be performed. In other examples, the compressed histogram can be directly processed (e.g., the output of FIG. 5A). For example, a CNN or a neural network can be used to process the encoded compressive histogram directly. In further examples, even if only a portion of the coding tensors is optimized, the decoding/decompression step can be performed. This step could be computed more efficiently for certain coding tensors.

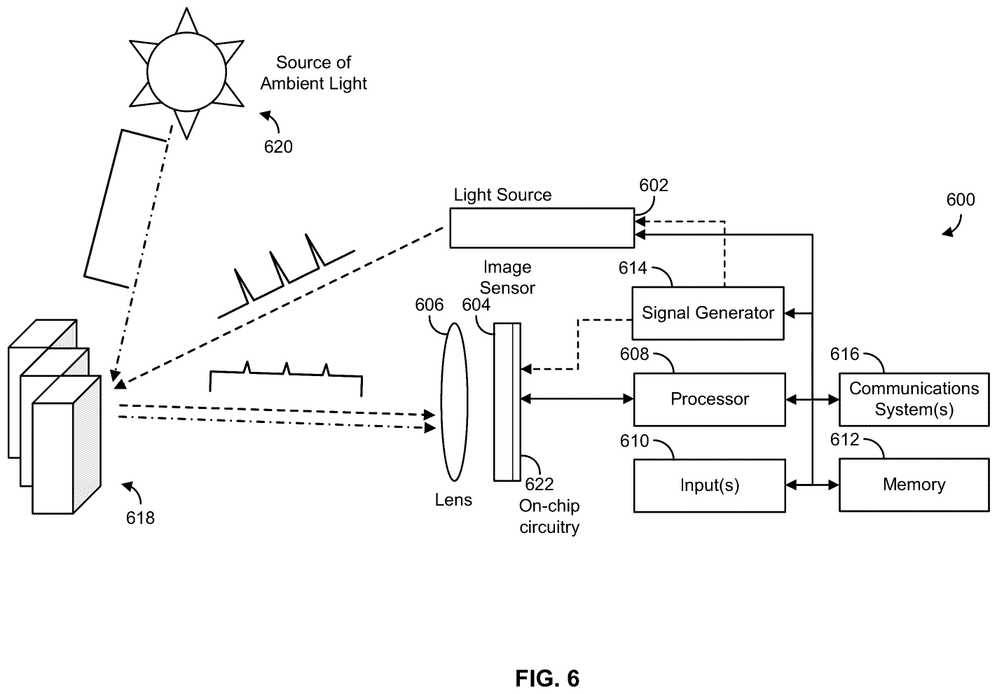

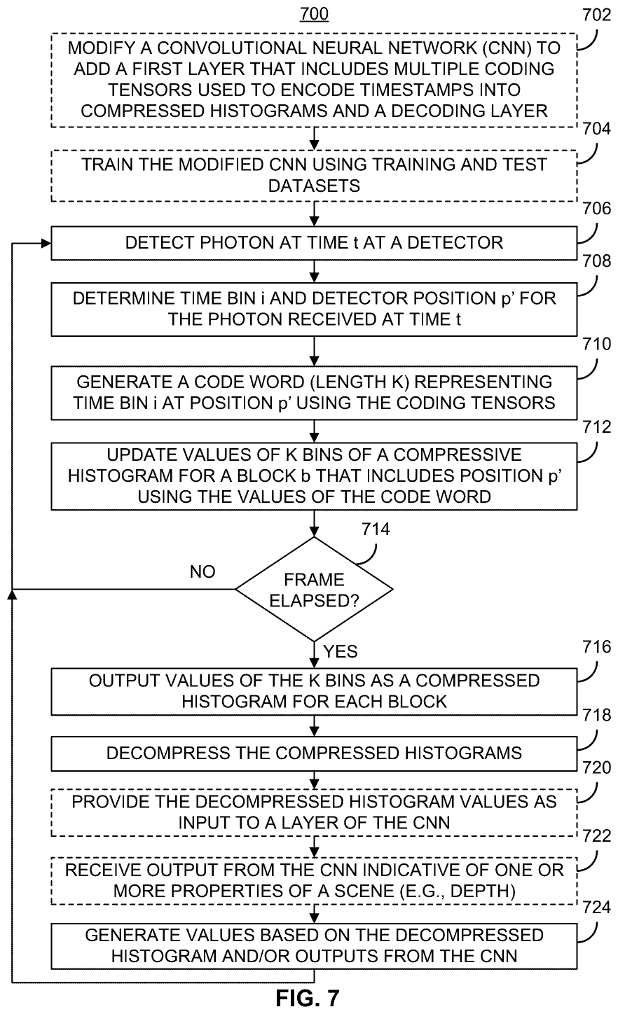

FIG. 6 shows an example 600 of a system for single photon depth imaging with improved efficiency using learned compressive representations in accordance with some embodiments of the disclosed subject matter. As shown, system 600 can include a light source 602; an image sensor 604 (e.g., an area sensor that includes an array of detectors, a single detector, or a line sensor that includes a linear array of detectors); optics 606 (which can include, for example, one or more lenses, one or more attenuation elements such as a filter, a diaphragm, and/or any other suitable optical elements such as a beam splitter, etc.), a processor 608 for controlling operations of system 600 which can include any suitable hardware processor (which can be a central processing unit (CPU), a graphics processing unit (GPU), an accelerate processing unit (APU), a digital signal processor (DSP), a microcontroller (MCU), a field programmable gate array (FPGA), an application-specific integrated circuit (ASIC), etc.) or combination of hardware processors; an input device/display 610 (such as a shutter button, a menu button, a microphone, a touchscreen, a motion sensor, a liquid crystal display, a light emitting diode display, etc., or any suitable combination thereof) for accepting input from a user and/or from the environment, and/or for presenting information (e.g., images, user interfaces, etc.) for consumption by a user; memory 612; a signal generator 614 for generating one or more signals to control operation of light source 602 and/or image sensor 604; a communication system or systems 616 for facilitating communication between system 600 and other devices, such as a smartphone, a wearable computer, a tablet computer, a laptop computer, a personal computer, a server, an embedded computer (e.g., for controlling an autonomous vehicle, robot, etc.), etc., via a communication link, and on-chip processing circuitry 622. In some embodiments, memory 612 can store histogram information, scene depth information, image data, and/or any other suitable data. Memory 612 can include a storage device (e.g., a hard disk, a Blu-ray disc, a Digital Video Disk, RAM, ROM, EEPROM, etc.) for storing a computer program for controlling processor 608. In some embodiments, memory 612 can include instructions for causing processor 608 to execute processes associated with the mechanisms described herein, such as a process described below in connection with FIG. 7.

In some embodiments, light source 602 can be any suitable light source that can be configured to emit modulated light (e.g., as a stream of pulses) toward a scene 618 illuminated by an ambient light source 620 in accordance with a signal received from signal generator 616. For example, light source 602 can include one or more laser diodes, one or more lasers, one or more light emitting diodes, and/or any other suitable light source. In some embodiments, light source 602 can emit light at any suitable wavelength. For example, light source 602 can emit ultraviolet light, visible light, near-infrared light, infrared light, etc. In a more particular example, light source 602 can be a coherent light source that emits light in the green portion of the visible spectrum (e.g., centered at 532 nm). In another more particular example, light source 602 can be a coherent light source that emits light in the infrared portion of the spectrum (e.g., centered at a wavelength in the near-infrared such as 1060 nm or 1064 nm).

In some embodiments, image sensor 604 can be an image sensor that is implemented at least in part using one or more SPAD detectors (sometimes referred to as a Geiger-mode avalanche diode) and/or one or more other detectors that are configured to detect the arrival time of individual photons. In some embodiments, one or more elements of image sensor 604 can be configured to generate data indicative of the arrival time of photons from the scene via optics 606. For example, in some embodiments, image sensor 604 can be a single SPAD detector. As another example, image sensor 604 can be an array of multiple SPAD detectors. As yet another example, image sensor 604 can be a hybrid array including one or more SPAD detectors and one or more conventional light detectors (e.g., CMOS-based pixels). As still another example, image sensor 604 can be multiple image sensors, such as a first image sensor that includes one or more SPAD detectors that is used to generate depth information and a second image sensor that includes one or more conventional pixels that is used to generate ambient brightness information and/or image data. In such an example, optical components can be included in optics 606 (e.g., multiple lenses, a beam splitter, etc.) to direct a portion of incoming light toward the SPAD-based image sensor and another portion toward the conventional image sensor that is used for light metering.

In some embodiments, image sensor 604 can include on-chip processing circuitry 622 that can be used to generate compressive histograms (e.g., using memory and logic implemented on the image sensor chip), which can be output to processor 608, which can facilitate a reduction in the volume of data transferred from image sensor 604. For example, single-photon detectors of image sensor 604 can be associated with circuitry that implements at least a portion of process 700, described below. As a particular example, single-photon detectors of image sensor 604 can be associated with circuitry that is configured to determine which bin of a full resolution histogram (e.g., which column and row of a block the detector is located in) is associated with a time at which a photon is detected.

As another more particular example, a single-photon detector or a group of single photon detectors of image sensor 604 can be associated with accumulators that are configured to update and store values for bins of the compressive histogram K associated with the single-photon detector(s) based on values of the code in a coding tensor associated with a time at which a photon is detected and the detector at which the photon was detected. In some embodiments, the accumulators can be implemented using any suitable technique or combination of techniques. For example, for a fully binary coding tensor (e.g., in which each element represents a 1 or a −1), the accumulators can be configured to increment or decrement by 1 from a current value (e.g., using a register configured to store a two's complement representation of an integer). As another example, for a coding tensor configured to use floating point values (e.g., Gray-based Fourier, Truncated Fourier, etc.), the accumulators can be configured to add a (positive or negative) multi bit value (e.g., a fixed-point number, a floating point number, an integer, etc.). As a more particular example, for a coding tensor configured to use fixed point values, the accumulators can be configured to add a (positive or negative) multi bit fixed point value (e.g., an 8-bit value, a 10 bit value, etc.). In some embodiments, a coding tensor can be configured to store values in a range of [−1,1] using fixed point values that each represent a value in the range (e.g., using only positive binary values, using a two's complement representation, etc.). In such an example, the value from the coding tensor can be converted into a floating point or fixed-point representation prior to being added to the accumulator, or values stored in an accumulator can be converted to a floating point or fixed-point representation prior to being used to calculate a depth value. In a more particular example, values in a coding tensor can be represented using a representation of a particular bit depth (e.g., using 8 bits, using 10 bits, using 12 bits, using two bytes, etc.), which can create a quantized representation of the value in the coding tensor (e.g., in an 8 bit quantized representation 0000 0000 can represent −1, 1111 1111 can represent 1, 0000 0001 can represent-0.9921875, etc.; in an 8 bit two's complement quantized representation 0000 0000 can represent 0, 1000 0000 can represent 31 1, 0111 1111 can represent 1, 1000 0001 can represent −0.9921875, etc.). In such an example, the values in the coding tensor can be represented using the closest value available in the quantized representation. In some embodiments, the accumulators can be implemented using various different hardware implementations.

As yet another more particular example, single-photon detectors of image sensor 604 can be associated with components (e.g., memory, logic, etc.) configured to store a representation of the coding tensors C. In some embodiments, a single representation of coding tensors C can be stored in on-chip memory, and can be accessed by circuitry associated with multiple single-photon detectors. For example, a single representation of coding tensors C can be stored in global memory (e.g., memory implemented on image sensor 604), and circuitry associated with each single-photon detector can be configured to retrieve coding tensors C from the global memory (e.g., in connection with each frame). As another example, a representation of coding tensors C can be stored in multiple local memories (e.g., associated with one or more single-photon detectors), and circuitry associated with each single-photon detector can be configured to retrieve coding tensors C from the local memory (e.g., in connection with each frame). Such local memory can be shared, for example, among a spatially local neighborhood of single-photon detectors of an array (e.g., among any suitable number of neighboring single-photon detectors, from several to hundreds, thousands, etc.). In such examples, image sensor 604 can be configured to use the representation(s) of the coding tensors C to update a compressive histogram associated with a single-photon detector or block of single-photon detectors responsive to detection of a photon.

In some embodiments, different coding tensors C can be used in connection with different time periods (e.g., coding matrices can be changed for difference frames) and/or for different areas of the image sensor. For example, during a first time period a first set of coding tensors C₁ with a first compression ratio can be used, and during another time period another set of coding tensors C₂ with a different compression ratio can be used. In such an example, the coding tensors C can be adjusted based on environmental conditions. For example, as the amount of ambient light increases, coding tensors C with a lower compression ratio can be used to reduce noise by decreasing compression. As described below in connection with FIGS. 8A to 12, accuracy is generally better for high signal-to-background noise conditions, and as the number of photons detected increases. Thus, in a portion of a scene (or at a time) having low ambient light, coding tensors C with a higher compression ratio can perform well, while in a portion of a scene (or at a time) having higher ambient light coding tensors C with a lower compression ratio may improve performance (but may necessitate a reduction in frame rate to fit within an available data transmission budget). In some such embodiments, multiple coding matrices can be stored in global memory (e.g., a memory implemented on image sensor 604, memory 612), and can be loaded to an appropriate memory for use in generating compressive histograms (e.g., to a local memory associated with a neighborhood of single-photon detectors when the coding tensor changes on a per neighborhood basis or changes between frames, and/or to a global memory used by all single-photon detectors when the coding tensor changes between frames).

In some embodiments, the on-chip processing circuitry can be implemented using any suitable fabrication techniques. For example, 3D-stacking CMOS techniques can be used to implement circuit components configured to generate a compressive histogram for each single-photon detector.

In some embodiments, system 600 can include additional optics. For example, although optics 606 is shown as a single lens and attenuation element, it can be implemented as a compound lens or combination of lenses. Note that although the mechanisms described herein are generally described as using SPAD-based detectors, this is merely an example of a single photon detector that is configured to record the arrival time of a pixel with a time resolution on the order of picoseconds, and other components can be used in place of SPAD detectors. For example, a photomultiplier tube in Geiger mode can be used to detect single photon arrivals.

In some embodiments, optics 606 can include optics for focusing light received from scene 618, one or more narrow bandpass filters centered around the wavelength of light emitted by light source 602, any other suitable optics, and/or any suitable combination thereof. In some embodiments, a single filter can be used for the entire area of image sensor 604 and/or multiple filters can be used that are each associated with a smaller area of image sensor 604 (e.g., with individual pixels or groups of pixels). Additionally, in some embodiments, optics 606 can include one or more optical components configured to attenuate the input flux (e.g., a neutral density filter, a diaphragm, etc.).

In some embodiments, system 600 can communicate with a remote device over a network using communication system(s) 614 and a communication link. Additionally, or alternatively, system 600 can be included as part of another device, such as a smartphone, a tablet computer, a laptop computer, an autonomous vehicle, a robot, etc. Parts of system 600 can be shared with a device within which system 600 is integrated. For example, if system 600 is integrated with an autonomous vehicle, processor 608 can be a processor of the autonomous vehicle and can be used to control operation of system 600.

In some embodiments, system 600 can communicate with any other suitable device, where the other device can be one of a general purpose device such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input devices, etc. For example, the other device can be implemented as a digital camera, security camera, outdoor monitoring system, a smartphone, a wearable computer, a tablet computer, a personal data assistant (PDA), a personal computer, a laptop computer, a multimedia terminal, a game console, a peripheral for a game counsel or any of the above devices, a special purpose device, etc.

Communications by communication system 614 via a communication link can be carried out using any suitable computer network, or any suitable combination of networks, including the Internet, an intranet, a wide-area network (WAN), a local-area network (LAN), a wireless network, a digital subscriber line (DSL) network, a frame relay network, an asynchronous transfer mode (ATM) network, a virtual private network (VPN). In further examples, data may also be transferred between one or more sensor chips to a processing chip/device using a universal serial bus (USB), a peripheral component interconnect express (PCIe), and/or low-voltage differential signaling (LVDS). The communications link can include any communication links suitable for communicating data between system 100 and another device, such as a network link, a dial-up link, a wireless link, a hard-wired link, any other suitable communication link, or any suitable combination of such links.

It should also be noted that data received through the communication link or any other communication link(s) can be received from any suitable source. In some embodiments, processor 608 can send and receive data through the communication link or any other communication link(s) using, for example, a transmitter, receiver, transmitter/receiver, transceiver, or any other suitable communication device.

FIG. 7 shows an example 700 of a process for improving the efficiency of transferring data from a single-photon image sensor in accordance with some embodiments of the disclosed subject matter.

At 702, process 700 can include modifying a convolutional neural network (CNN) to add a first layer that includes multiple coding tensors (e.g., coding tensors C) that can be used to encode timestamps corresponding to detected photons into compressed histograms. For example, a layer that includes K convolutional filters, as described above in connection with FIGS. 4 and 5A.

Additionally, at 702, in some embodiments, process 700 can include modifying the CNN to add a decoding layer that can be used to decode the compressed histograms into an uncompressed histogram with the same dimension as an uncompressed 3D histogram tensor that would be generated from raw timestamp information.

In some embodiments, 702 can be omitted. For example, in an implementation in which a downstream CNN is not used to analyze the data, the first layer and decoding layer can be implemented without modifying a pre-existing CNN architecture.

At 704, process 700 can include training the modified CNN using training and test datasets. For example, in some embodiments, the CNN modified at 702 can be a pre-trained CNN (e.g., trained to perform depth estimation from 3D histogram tensor data), and at 704 the first layer can be trained, without further training the rest of the CNN. As another example, in some embodiments, the CNN modified at 702 can be a pre-trained CNN (e.g., trained to perform depth estimation from 3D histogram tensor data), and at 704 the first layer can be trained along with further training of other layers of the CNN. As yet another example, in some embodiments, the CNN modified at 702 can be an untrained or partially trained CNN, and at 704 the first layer can be trained along with training of other layers of the CNN.

In some embodiments, weights for portions of the first layer can be trained (e.g., a spatial portion of a separable coding tensor) and weights for another portion of the first layer (e.g., a temporal portion of the separable coding tensor) can be predetermined.

In some embodiments, 704 can be omitted. For example, in an implementation in which coding tensors are not learned, the first layer and decoding layer can be implemented without training.

At 706, process 700 can detect an arrival of photon at a single-photon detector at time t using any suitable technique or combination of techniques. For example, process 700 can detect the arrival of a photon based on activation of a SPAD, which can cause a timestamp (e.g., by a time-to-digital converter) corresponding to the time t at which the photon was detected to be generated. The single-photon detector at which the photon was detected can be associated with a position within an array of single-photon detectors, which can correspond to a particular position within a particular block H_{b} of a 3D histogram tensor H.

At 708, process 700 can determine a time bin i of a histogram (e.g., a full-resolution histogram having a number of time bins corresponding to a full 3D histogram tensor H) for the photon detected at time t using any suitable technique or combination of techniques. For example, process 700 can determine a difference between a time when a light source emitted a pulse, and time t when the photon was detected, and can determine which bin of the histogram corresponds to the time difference.

Additionally, at 708, process 700 can determine a position p′ of the detector at which the photon was detected using any suitable technique or combination of techniques. For example, p′ can be a position of the pixel where the photon was detected. This information can be obtained by using a logic in the SPAD.

At 710, process 700 can generate a code word (e.g., of length K) representing time bin i for position p′ using coding tensors C, and the relative position of p′ within block H_{b}. For example, as described above in connection with FIGS. 4 and 5A, the position p′ at which a photon is detected can be encoded as a one-hot tensor that can be convolved with the K coding tensors.

At 712, process 700 can update the values of K bins of a compressive histogram for a block b that includes position p′. For example, process 700 can update values in a memory storing K bins of the compressive histogram for block b. As another example, process 700 can update values of K accumulators used to store the values of the compressive histogram being constructed for block b. For example, each value in the code word can be added to a corresponding bin of the K bins or accumulator of the K accumulators. In some embodiments, accumulator updates can be performed using various techniques, and the techniques used can depend on the implementation of the coding tensor (e.g., using integers, fixed-point numbers, floating point numbers, etc.).

At 714, process 700 can determine whether a frame has elapsed (e.g., whether a time period corresponding to a single depth measurement has elapsed). For example, after a time associated with a frame (e.g., 33 milliseconds at 30 fps, 10 milliseconds at 100 fps) has elapsed from a previous readout (e.g., based on a reset signal), process 700 can determine that a frame has elapsed.

If process 700 determines that a frame has not elapsed (“NO” at 714), process 700 can return to 706 and can detect a next photon. Note that a photon may not be detected for each light source emission, and process 700 can move from 706 to 714 without a photon detection if a detection period T has elapsed without a photon detection. In some embodiments, process 700 can move from 706 to 714 for each detector during each detection period τ.

Otherwise, if process 700 determines that a frame has elapsed (“YES” at 714), process 700 can move to 716. At 716, process 700 can output values from the K bins of the compressive histogram associated with each block. For example, after a frame has elapsed, process 700 can output the values of the K bins to processor 608.

At 718, process 700 can decode and/or decompress the compressed histogram values for each block (e.g., using techniques described above in connection with FIG. 5B). In some embodiments, decompressing can include concatenating blocks decoded from the compressed histogram associated with each block. In some embodiments, at 718 process 700 can generate a 3D tensor histogram H that can represent the information aggregated across photons detected at 706. In some examples, step 718 can be made optional if the CNN or neural network is trained to work with the compressive histogram directly. In some examples, the decompression step can be used if the CNN is a 3D CNN. The 3D CNNs can be used to process 3D histogram tensor. In other examples, other CNNs (e.g., 2D CNN) or neural networks can be used directly on the compressive histogram (i.e., the output of 716).

At 720, process 700 can provide the decompressed histogram values as input to a layer of the modified CNN. For example, process 700 can provide a 3D tensor histogram H decoded from the compressed histograms for each block to a subsequent layer of the CNN.

At 722, process 700 can receive an output from the CNN indicative of one or more properties of the scene based on the information included in the decompressed histogram. For example, process 700 can receive depth values as output from the CNN. As another example, process 700 can receive lifetime values (e.g., in FLIM imaging) as output from the CNN.

In some embodiments, 720 and/or 722 can be omitted. For example, in an implementation in which a CNN is not used to generate depth or other values (e.g., where depth values or other values are calculated directly from the histogram values).

At 724, process 700 can generate values based on the decompressed histogram and/or outputs from the CNN received at 722. For example, process 700 can use any suitable technique or combination of techniques to determine a depth value from the decompressed histogram (such as techniques described in connection with 814 of FIG. 8 in U.S. patent application Ser. No. 17/834,884, which has been incorporated by reference herein). As another example, process 700 can use the outputs from CNN to calculate values. In some examples, process 700 can perform an imaging task based on the values. For example, process 700 can estimate a depth value based on the values (e.g., in SPAD LiDAR three-dimensional imaging, Fluorescence lifetime imaging, Non-line-of-sight (NLOS) imaging, computer vision imaging, or any other suitable imaging task).

In some embodiments, one or more portions of process 700 can be repeated for each frame and/or for each block of single-photon detectors (e.g., each block of SPAD outputs) of the image sensor.

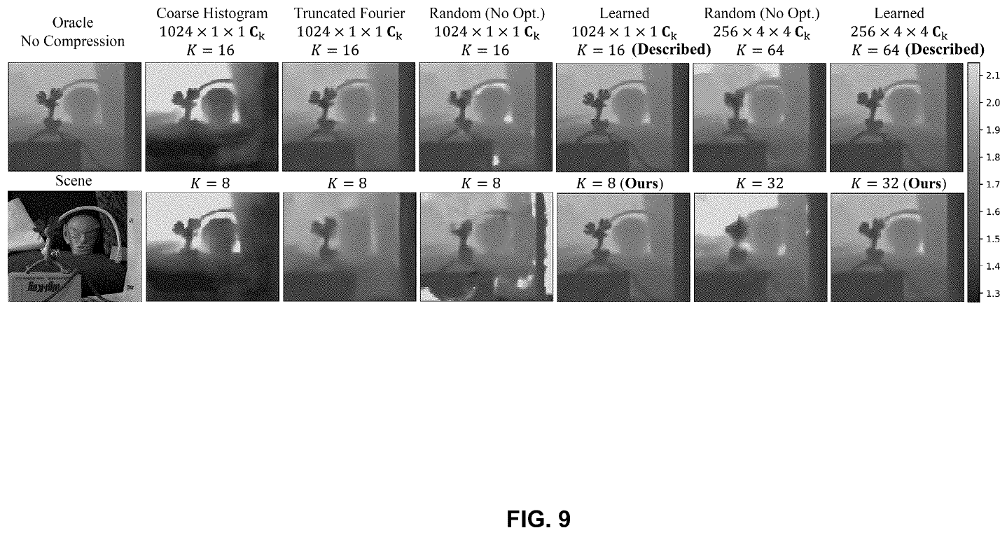

In some embodiments, depth values generated using process 700 can be used to generate a depth image (e.g., such as depth images shown in FIGS. 9-12).

FIGS. 8A to 13 show examples demonstrating results generated using techniques described herein on synthetic and real binary frame sequences.

Datasets used for model training and testing are described below, as well as implementation details for the compressive histogram layer and the 3D CNN used for the experiments.

For training, a synthetic SPAD measurement dataset including different scenes at a wide range of illumination settings were generated. A similar synthetic data generation pipeline was used as in previous learning-based SPAD-based 3D imaging works (e.g., as described in Peng et al., “Photon-efficient 3d imaging with a non-local neural network”; Lindell et al., “Single-photon 3d imaging with deep sensor fusion”; and Sun et al., “Spadnet: deep rgb-spad sensor fusion assisted by monocular depth estimation,” Optics Express, 28 (10): 14948-14962 (2020)). Using EQ. (2), SPAD measurements can be simulated given an RGB-D image, the pulse waveform (h(t)), and the average number of detected signal and background photons per pixel. Additional details of the simulation pipeline used are described below.

Simulated Training Dataset: RGB-D images from the NYU v2 dataset were used to generate a simulated training dataset. The simulated histograms have Nₜ=1024 bins and a Δ=80 picosecond (ps) bin size (corresponding to a 12.3 meter (m) depth range). The pulse waveform used has a full-width half maximum (FWHM) of 400 ps. For each scene, the average number of signal and background photons detected per pixel were randomly set to [2, 5, or 10] and [2, 10, 50], respectively. With appropriate normalization, the models generalize to other photon levels despite being trained on this photon-starved dataset. A total of 16,628 histogram tensors with dimensions 1024×64×64 were simulated and split into a training and a validation set with 13,851 and 2,777 examples, respectively.

Simulated Test Dataset: For testing 8 RGB-D images from the Middlebury stereo dataset were used. The simulated histograms have Nₜ=1024 bins and a 4=100 ps bin size (corresponding to a 15.3 m depth range). The pulse waveform used is a Gaussian pulse with an FWHM of 318 ps (with a σ=135 ps). In some examples, σ is the variance of the Gaussian pulse. The width of the Gaussian pulse can be described using the FWHM or the variance of the Gaussian. A total of 128 test histogram tensors were generated by simulating each scene with the following average number of detected signal/background photons: 2/2, 2/5, 2/50, 5/2, 5/10, 5/50, 10/2, 10/10, 10/50, 10/200, 10/500, 10/1000, 50/50, 50/200, 50/500, and 50/1000.

Real-world Experimental Data: An evaluation of the generalization of our models to real-world experimental data captured in Lindell et al., “Single-photon 3d imaging with deep sensor fusion” is described.

To simplify training, the input to all models was a 3D histogram tensor, though techniques for generating compressive histograms can be used directly on streams of photon timestamps (EQ. (4)).

Compressive Histogram Layer: The encoder was implemented as a 3D convolution with a stride equal to the filter size, with learned filters that are the coding tensors, Cₖ. A constraint was applied to Cₖ to be zero-mean along the time dimension. The unfiltered backprojection decoder was implemented as a 3D transposed convolution with a stride equal to its filter size. To help the CNN model generalize to different photon count levels zero-normalization was applied along the channel dimension (along K) to the inputs (Ŷ_{b}) and the weights (C) of the transposed convolution, sometimes referred to as layer-norm. This normalization is also commonly used in depth decoding algorithms.

Depth Estimation 3D CNN: To estimate depths from the decoded histogram tensor, the 3D deep boosting CNN model described in Peng et al., “Photon-efficient 3d imaging with a non-local neural network,” was used for single-photon 3D imaging, without the non-local block. Similar to Peng et al., “Photon-efficient 3d imaging with a non-local neural network,” and Lindell et al., “Single-photon 3d imaging with deep sensor fusion,” the pixel-wise KL-divergence between the output histogram tensor and a normalized true histogram tensor was used as the objective, and depths were estimated using a softargmax. In some examples, the models including the encoding and decoding layers can be trained without using pre-trained models. In other examples, a pre-trained 3D CNN can be used by fine-tuning the model while the encoding layer is trained. In some embodiments, the decoding layer may not trained. The decoding layer can depend on the weights of the encoding layer. In other examples, only a subset of the weights of the encoding layer (i.e., parts of the coding tensors) can be trained. For example, some weights can be selected and initialized to initialized code (e.g., Fourier codes). Then, the other weights can be learned.

Training: At each training iteration patches of size 1024×32×32 were randomly sampled. All models were trained using the ADAM optimizer with β₁=0.9, β₂=0.999, batch size of 4, and a learning rate of 0.001 that decays by 0.9 after every epoch. All models were trained for 30 epochs with periodical checkpoints, and for a given model the checkpoint was chosen that achieves the lowest root mean squared error (RMSE) on the validation set.

The performance at various compression levels for different coding tensor designs jointly optimized with the depth estimation CNN described above are described below. A coding tensor design was determined by the dimensions of Cₖ (Mₜ×Mᵣ×M_{c}), the size of the compressive histograms (K), and if Cₖ is separable.

Comparisons are against the following baselines:

Temporal Truncated Fourier: A compressive histogram that uses coding tensors with dimensions 1024×1×1 and whose weights are set using the first K/2 frequencies of the Fourier matrix (e.g., as described in Gutierrez-Barragan et al., “Compressive single-photon 3d cameras,” in Proceedings of the IEEE/CVF conference on Computer Vision and Pattern Recognition, pp. 17854-17864 (2022), and Shechan et al., “A sketching framework for reduced data transfer in photon counting lidar,” IEEE Transactions on Computational Imaging, 7:989-1004 (2021).

Temporal Coarse Histogram: Here C is a box downsampling operator along the temporal dimensions which produces a coarse histogram with K bins.

No Compression Oracle: In this baseline, the ideal scenario is assumed where the histogram tensor is transferred off-sensor and processed with the depth estimation 3D CNN. Similar to Peng et al., “Photon-efficient 3d imaging with a non-local neural network,” this model was trained with an initial learning rate of 1e-4 and total variation regularization.

Peak Compression Oracle: This baseline implements an ideal SPAD camera with sufficient in-sensor memory to store a histogram tensor and sufficient computation power to compute per-pixel depths through an argmax along the temporal axis. To process the noisy 2D depth images with the 3D CNN, a 3D grid was generated where all elements are 0 except for one element per spatial location whose index is proportional to the depth value. This model was trained like the no compression oracle.

Similar to mechanisms described herein, all compressive histogram baselines described here were implemented as a compressive histogram layer, with fixed weights, whose outputs were processed by the depth estimation 3D CNN.

Evaluation Metrics: The 3D imaging performance of each model was summarized using two metrics: (1) the mean absolute depth error (MAE), and (2) and the percent of pixels with absolute depth errors that are lower than 10 mm. To understand the performance under these metrics the test set was divided into different SBR ranges and the metrics for each range were reported individually. The overall dataset performance was also visualized as scatter plots (e.g., as shown in FIG. 9) where each point shows the MAE for a given test scene and the color hue represents the mean SBR of the scene. Outliers with an MAE larger than 50 mm were not visible in the plot, however, they are included in the calculation of the statistics. When comparing different compressive histogram strategies the compression ratio is fixed. The compression ratio (CR) is the ratio of the block size and the length of the compressive histogram (CR=(Mₜ·Mᵣ·M_{c}·)/K).

FIGS. 8A and 8B show examples of compression ratio with mean absolute depth errors and a percent of pixels with errors, respectively, computed over a test set for various techniques for estimating depth in a single photon depth imaging system.

FIG. 8A shows two plots of the mean absolute error computed over the test set as we increase compression. Similarly, FIG. 8B shows two plots of the mean percent of pixels whose absolute depth errors were <10 mm. The simulated test set images were divided into low (SBR≤0.1) and high (SBR>0.1) SBR groups to facilitate disentangling the impact of SBR on the performance of each model. The dashed lines show the peak and no compression baselines whose compression levels do not vary. In FIG. 8A the top line is the 64-bin Coarse histogram, the middle line is the peak compression oracle, and the bottom line is the no compression oracle, whereas in FIG. 8B the top line is the no compression oracle, the middle line is the peak compression oracle, and the bottom line is the 64-bin Coarse histogram. Each solid line corresponds to a fixed coding tensor design for which K is varied to control the compression level. Additionally, each point for a given compression level corresponds to a single set of coding tensors jointly optimized with the depth estimation 3D CNN.

As shown in FIGS. 8A and 8B, the learned coding tensors consistently outperformed the temporal Fourier-based scheme. At low SBR and CR>100, it becomes more important for the learned coding tensors to utilize spatio-temporal information (see lines (3) and (4) in FIGS. 8A and 8B). Additionally, the proposed models can outperform the peak compression oracle for CR≤64. Overall, learned spatio-temporal coding tensors provide robust performance that degrades gracefully as compression increases.

FIG. 9 shows examples of depth reconstructions generated using compressed histograms generating using various techniques including manually designed coding tensors, randomly initialized coding tensors, and learned coding tensors in accordance with some embodiments of the disclosed subject matter.

FIG. 9 shows depth reconstructions at 64× (top) and 128× (bottom) compression for compressive histogram models with coding tensors that were hand-designed (coarse histogram and Fourier-based), learned (using mechanisms described herein), and not learned (randomly initialized). The simulated scene had an SBR=0.1, where the mean signal and background photon levels were [50, 500].

Comparisons of depth reconstructions of compressive histograms with coding tensors that were optimized (using mechanisms described herein) against coding tensors that were fixed and not optimized throughout training are shown in FIG. 9. The extreme quantization in coarse histograms causes large systematic depth errors. Random unoptimized coding tensors consistently produce lower-quality depth reconstructions. A well-designed coding tensor based on Fourier codes can produce reasonable depth reconstructions at 64× compression, however, at 128× compression, scene details become blurred. The learned coding tensors were able to generate high-quality reconstructions comparable to the no-compression oracle. Overall, optimizing the coding tensors can provide non-trivial performance gains.

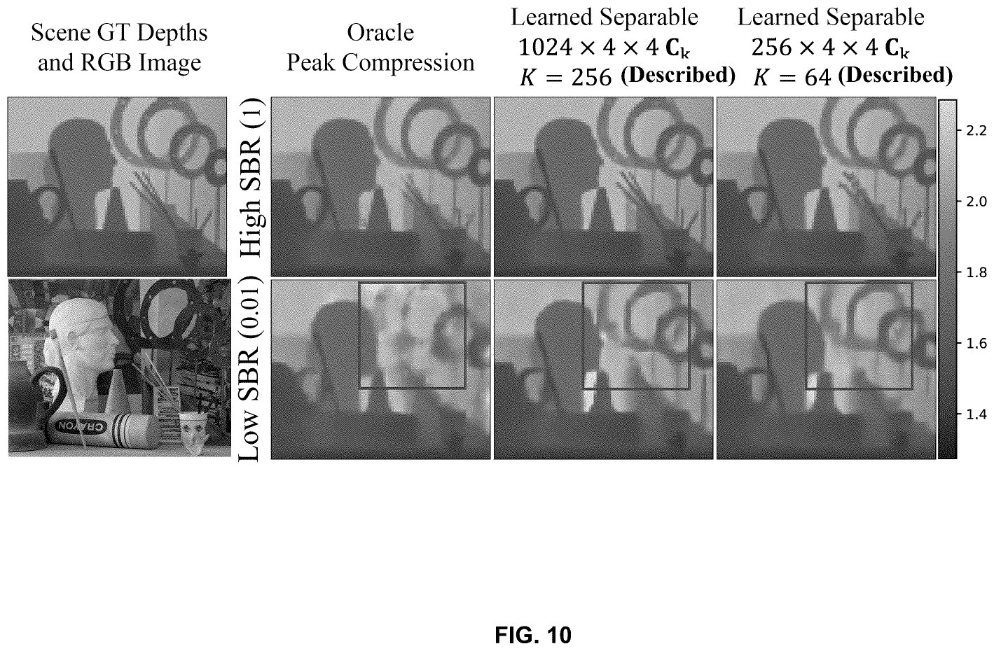

FIG. 10 shows examples of depth reconstructions generated from single-photon data compressed using various techniques, including on-chip depth calculation, and learned coding tensors in accordance with some embodiments of the disclosed subject matter.

In FIG. 10, depth reconstructions at high and low SBR with mean signal and background photon levels of [10, 10] and [10, 1000], respectively are shown. The compressive histograms have a compression of 64. A comparison of the depth reconstruction quality of two learned coding tensors at 64× compression with the peak compression oracle described above are shown. At high SBR, all techniques recover the fine and coarse scene details. At low SBR the peak compression oracle fails to reconstruct high-level scene structures such as the rings in the box, while the learned coding tensors better preserve these coarse and fine details.

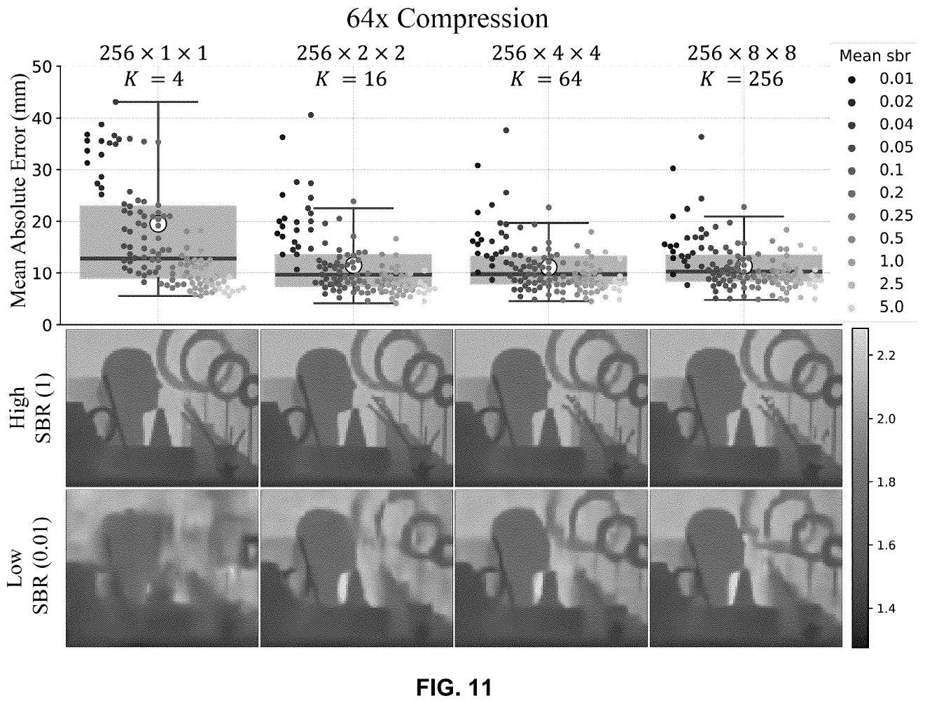

FIG. 11 shows examples of depth reconstructions generated from single-photon data compressed using different spatial block sizes of learned coding tensors in accordance with some embodiments of the disclosed subject matter at a fixed compression ratio and associated mean average error.

Each scatter plot point in FIG. 11 corresponds to the MAE of a test scene. The images directly below each model correspond to the depth reconstructions for two test examples at high and low SBR levels whose mean signal and background photons per pixel are [10, 10] and [10, 1000], respectively. For a fixed compression level, the spatial block size of each model is increased from left to right and K is adjusted to maintain the same compression level. The coding tensors for all models in this plot were learned and are separable. In some examples, both parts of the coding sensor can be learned. In other examples, only the spatial part of the coding sensor can be learned.

In FIG. 11, the effect of increasing the spatial dimension of C is shown at 64× compression. At high SBR, all techniques have similar MAE, but coding tensors with smaller spatial dimensions better preserve fine details (e.g., sticks). On the other hand, at low SBR, coding tensors with larger spatial dimensions preserve high-level details such as the pot handle. This difference is also observed in the scatter plot where the mean and median of the 256×1×1 do not match which indicates multiple low SBR scenes with high MAE.

FIG. 12 shows examples of depth reconstructions generated from single-photon data compressed using different spatial block sizes of learned coding tensors in accordance with some embodiments of the disclosed subject matter at a higher fixed compression ratio and associated mean average error.

Each scatter plot point in FIG. 12 corresponds to the MAE of a test scene. The images directly below each model correspond to the depth reconstructions for two test scenes at high and low SBR levels whose mean signal and background photons per pixel are [10, 10] and [10, 1000], respectively. The size of C is reduced from left to right by making it separable or reducing the Mₜ.

The effect of reducing the size of C at 128× compression is shown in FIG. 12. The coding tensors size was reduced by training models with separable coding tensors that operate on smaller histogram blocks. In some examples, both parts of the coding sensor can be learned. In other examples, only the spatial part of the coding sensor can be learned. The performance difference between full and separable coding tensors (1024×4×4) is negligible in FIG. 12. As the number of parameters in C was further reduced, the overall performance degrades. Coding tensors with fewer parameters that operate on smaller histogram blocks tend to produce blurrier reconstructions in FIG. 12. This can be observed in the inset box where the coding tensors with less than 10,000 parameters blur the spikes. However, as discussed above in connection with 0.4, a parameter-efficient C is desirable due to limits on in-sensor memory availability. Ultimately, a practical compressive SPAD-based 3D camera design can require trade-offs between parameter efficiency and 3D imaging quality, which may be application dependent.

Dataset Bias in Learned Coding Tensors with Mₜ=Nₜ: The training dataset depth bias that is embedded in some coding tensor designs is analyzed, and its effect on generalization to scenes with depths that appear less often in the dataset.

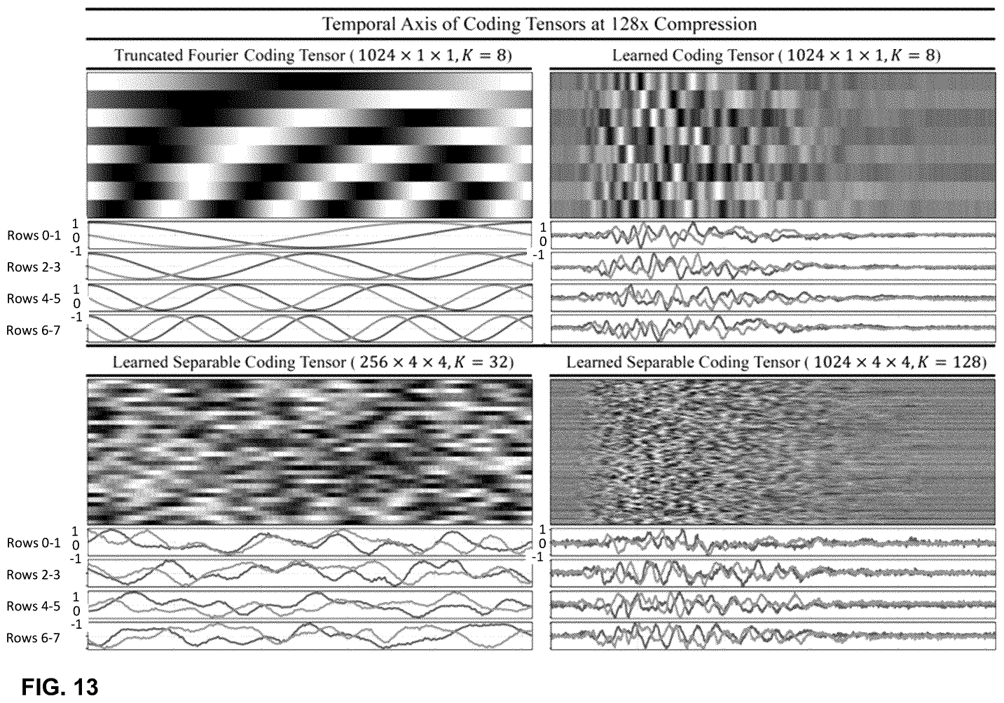

Depth Range Bias in Learned Coding Tensors: FIG. 13 visualizes the temporal dimension for different coding tensor designs as a matrix. In FIG. 13, visualization of the temporal dimension for different coding tensors achieve 128× compression. The matrix visualized for coding tensors of dimension 1024×1×1 (columns 1 and 2) is an 8×1024 matrix, since K=8 and Mₜ=1024. On the other hand, the matrix for the learned separable 256×4×4ₖ is 32×256 since K=32 and Mₜ=256. Similarly, the matrix for the learned separable 1024×4×4ₖ is a 128×1024 matrix. The bias on the learned coding tensors with Mₜ=1024 is displayed on the weights whose magnitude is close to 0 on the right-most side of the matrices. The learned coding tensors that operate on the full temporal dimension (i.e., Mₜ=Nₜ=1024) show structure in approximately the first half of the matrix, and in the second half their magnitude is close to 0. In some examples, coding tensors may have depth ambiguities in the second half of the depth range and may not be robust to noise when estimating depths in that range. These learned coding tensors are consistent with the depth range observed in the NYUv2 training dataset whose depths are concentrated between 0.5-7m (i.e., close to half of the depth range in our simulation). The results in the Detailed Description only included test scenes with depths <7m, therefore, this bias had little impact on the performance. To further analyze the impact of this bias on generalization, in the remainder of this section the models are evaluated on a modified Middlebury test set that contains a global depth offset of 7m, making its depth range 7-10 (meters).

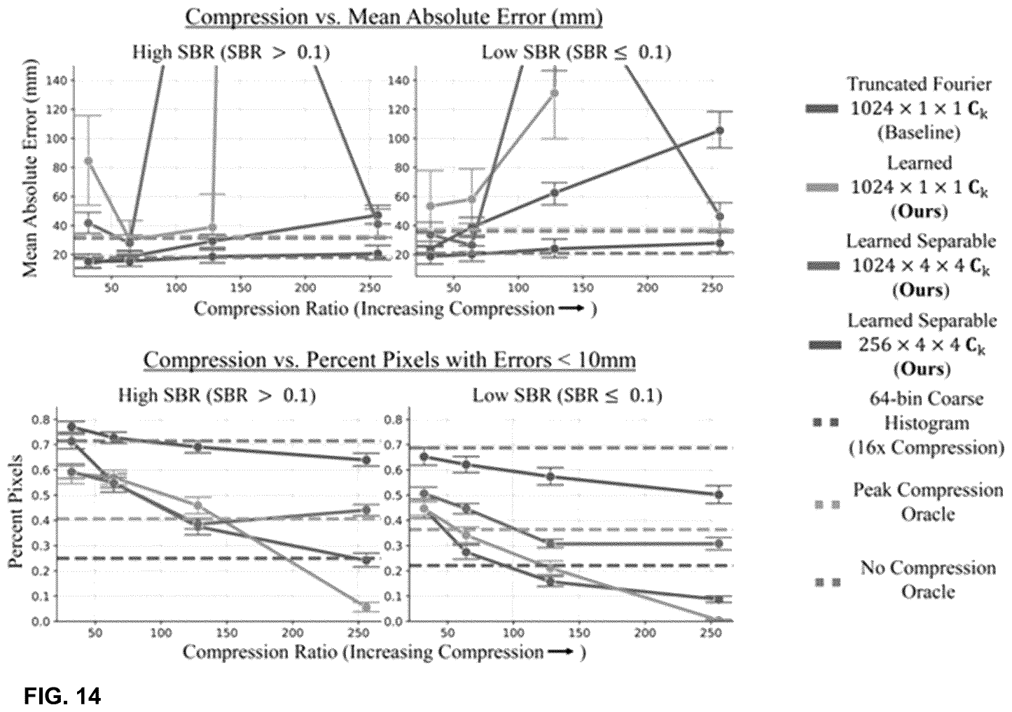

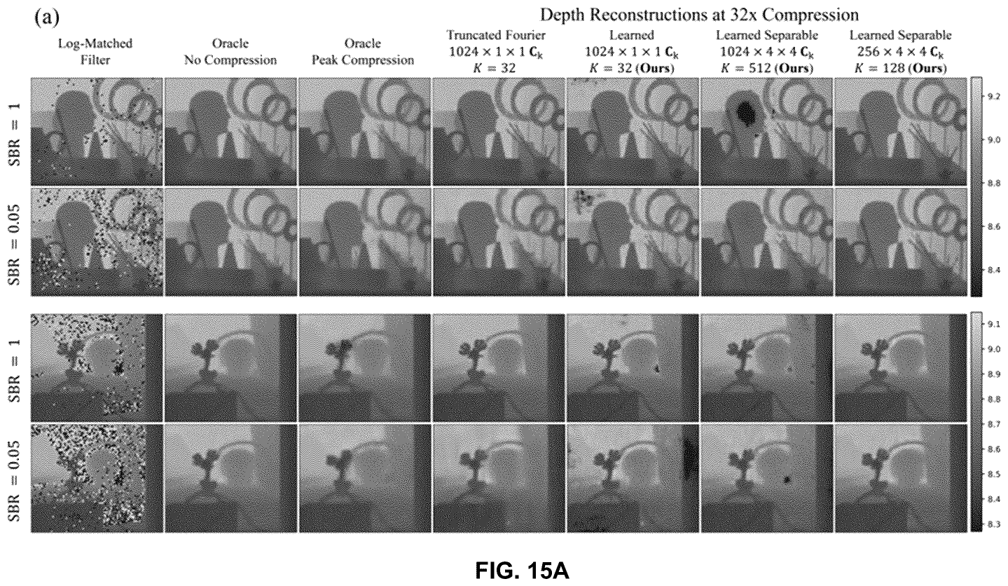

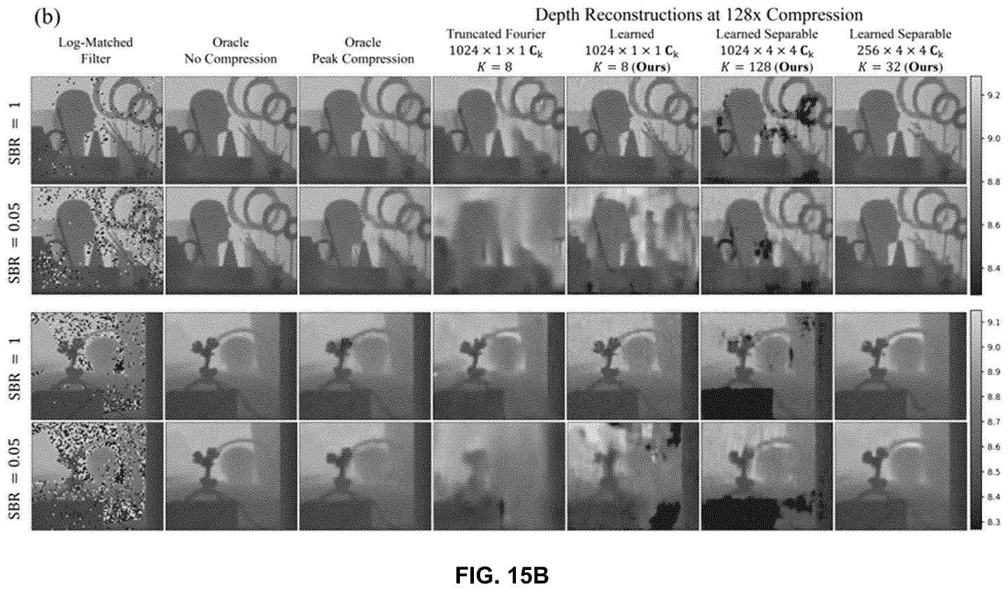

Quantitative Performance Analysis on Depths Between 7-10m: FIG. 14 shows how the performance of different compressive histogram models varies as a function of the compression ratio. FIG. 14 shows performance on the Middlebury test set with a 7 meter depth offset applied to all depth images before simulation. The two left-most plots show the mean absolute error computed over the test set as compression increased. Similarly, the two right-most plots show the mean percent of pixels whose absolute depth errors were <10 mm. The simulated test set images were divided into low (SBR≤0.1) and high (SBR >0.1) SBR groups to be able to disentangle the impact of SBR on the performance of each model. The dashed lines show the peak and no compression baselines whose compression levels do not vary. Each line corresponds to a fixed coding tensor design for which K is varied to control the compression level. Moreover, each point for a given compression level corresponds to a single set of coding tensors jointly optimized with the depth estimation 3D CNN. The learned coding tensors with Mₜ=Nₜ=1024 (orange and green lines) show significantly elevated MAE compared to a learned with Mₜ=256. This poor performance is due to the depth reconstruction artifacts observed in FIG. 15. The learned coding tensors with Mₜ=Nₜ=1024 (i.e, orange and green lines) consistently display poor performance across all compression levels. Moreover, the variance in their MAE is very high which is likely due to generalization artifacts. Fourier-based coding tensors (blue line) continue to achieve reasonable performance at CR<64 and poor performance for higher compression levels, which is consistent with the results in the main paper. Finally, the learned coding tensor with Mₜ<Nₜ (red line) displays good performance across all compression and SBR levels, comparable to the results in the Detailed Description, despite the aforementioned.

Qualitative Performance Analysis on Depths Between 7-10m: FIG. 15 shows the depth reconstruction for multiple baselines and compressive histograms at 32× and 128× compression. Depths are recovered for two scenes whose depths range between 7m and 9.5m. The compressive histogram models achieve 32× (a) and 128× (b) compression. The SBR levels of 1 and 0.05 correspond to a scene simulated with an average number of detected photons per pixel of [10,10] and [10,200]. Learned coding tensors with Mₜ=Nₜ=1024 produce reconstructions with multiple artifacts which indicates that they have poor generalization for this range of depths, which is consistent with the observed depth range bias observed in FIG. 13. The recovered depth images with learned coding tensors with Mₜ=Nₜ=1024 display multiple artifacts at both high (1) and low (0.05) SBR for both scenes. These artifacts explain why elevated MAE is observed in FIG. 14, but at the same time, the percent pixels with errors <10 mm is not incredibly low for some compression levels. On the other hand, the learned separable 256×4×4 not only obtains artifact-free reconstructions but also continues to show the same trends observed in the results in the Detailed Description. For instance, at 128× compression and SBR=0.05, it is able to preserve important scene information that is lost when using a Truncated Fourier.

In general, dataset bias can be analyzed in any learning-based model. It was found that this bias can lead to learned coding tensors that only work well for a subset of depths. One way to resolve this problem is by augmenting the dataset to include examples with depths for the full depth range. However, an even simpler approach is to consider a coding tensor design that considers a smaller block size, making the tensor convolutional. In the disclosure, it was shown that the learned coding tensors that are robust to this dataset bias, continue to provide the same performance benefits that were observed.

Supplemental Analysis of the Coding Tensor Design Space: In this section, additional results related to the ablation study on the coding tensor design space are presented. These results include the effect of the spatial block dimensions, the effect of the size of C, and the performance difference between coding tensors whose temporal dimension is learned vs coding tensors whose temporal dimension is initialized and fixed to truncated Fourier codes.

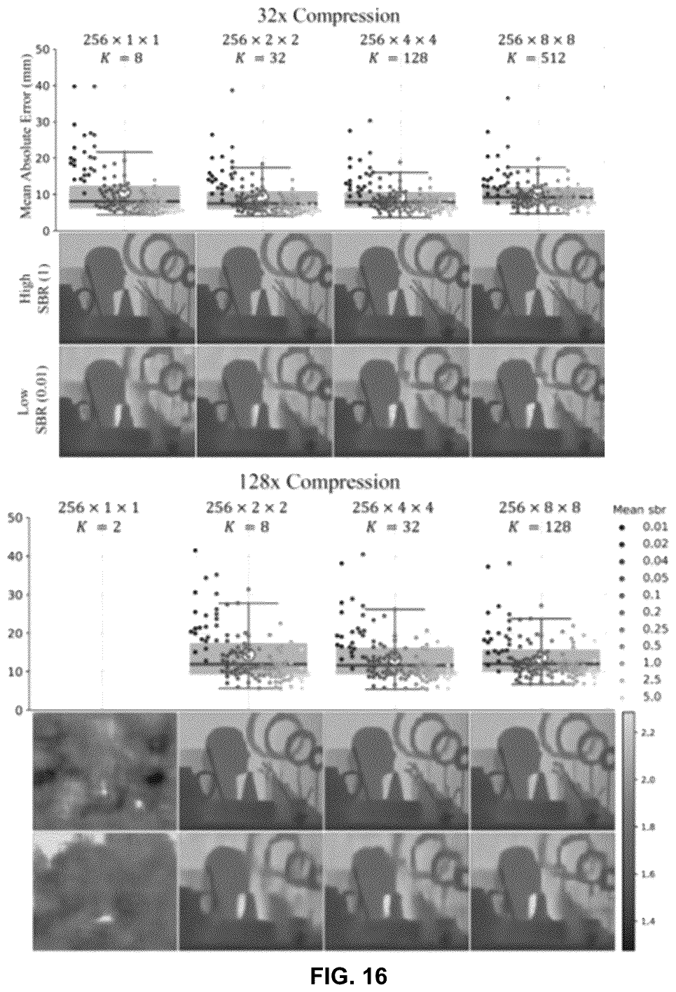

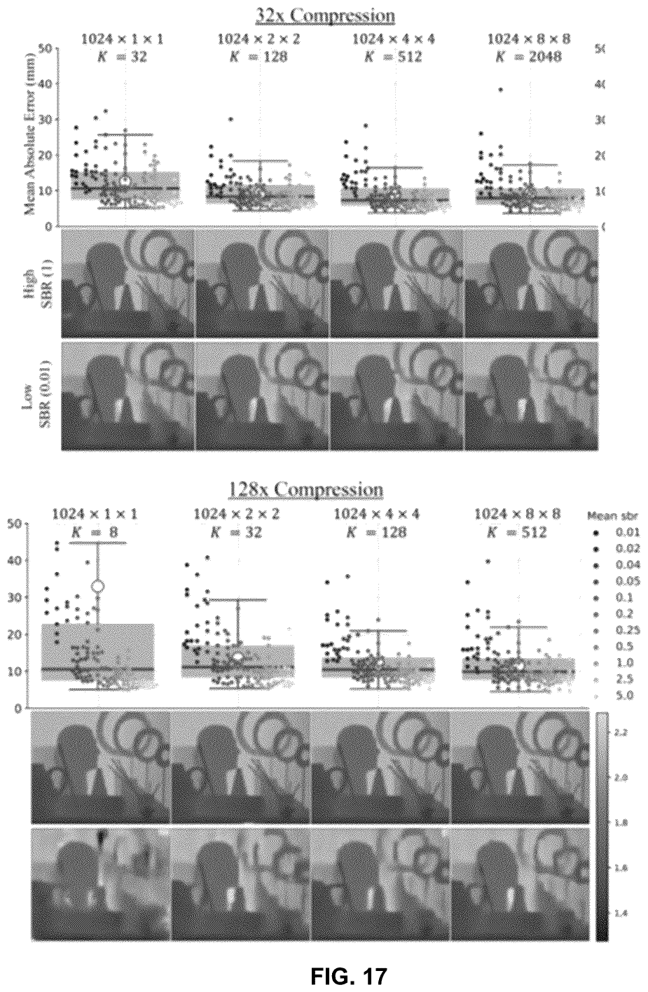

FIGS. 16 and 17 show the quantitative and qualitative performance of learned separable coding tensors as their spatial block dimension is varied from 1×1 up to 8×8. In FIG. 16, each point in the scatter plots shows the MAE for a given test scene and their color hue represent the mean SBR level used in that simulation. The horizontal black line, white circle, gray box, and error bars correspond to the median, mean, quartiles, and 1.5× the inter-quantile range, respectively. Outliers with an MAE larger than 50 mm are not visible in the plot, however, they are included in the calculation of the statistics. The images directly below each model correspond to the depth reconstructions for two test examples at low and high SBR levels whose mean signal and background photon detections per pixel are [10, 10] and [10, 1000], respectively. For a fixed compression level, the spatial block size of each model is increased from left to right and K is adjusted to maintain the same compression level. The coding tensors for all models in this plot are learned and separable for spatial blocks larger than 1×1. In FIG. 17, each point in the scatter plots shows the MAE for a given test scene and their color hue represent the mean SBR level used in that simulation. The horizontal black line, white circle, gray box, and error bars correspond to the median, mean, quartiles, and 1.5× the inter-quantile range, respectively. Outliers with an MAE larger than 50 mm are not visible in the plot, however, they are included in the calculation of the statistics. The images directly below each model correspond to the depth reconstructions for two test examples at low and high SBR levels whose mean signal and background photon detections per pixel are [10, 10] and [10, 1000], respectively. For a fixed compression level, the spatial block size of each model is increased from left to right and K is adjusted to maintain the same compression level. The coding tensors for all models in this plot are learned and separable for spatial blocks larger than 1×1. At low compression (32×) and high SBR levels, all models are able to produce high-quality reconstructions that recover both coarse and fine details of the scene. At low compression (32×) and extremely low SBR, models with a spatial block larger than 1×1 are able to better preserve some of the coarser scene details such as the sticks. However, quantitatively, the overall performance difference is small. At high compression and high SBR, models with a 2×2 and 4×4 spatial block are able to recover fine details that are blurred in the 8×8, which are particularly noticeable in FIG. A7. Finally, in the most challenging scenario with high compression and low SBR, it becomes more important to use a coding tensor that aggregates information from neighboring spatial locations. In this scenario, although all techniques blur some fine scene details, the coding tensors with large spatial dimensions better preserve coarser details such as the pot handle and the sticks.

Why does 256×1×1 fail at 128× compression? As observed in FIG. 6, the coding tensor with dimensions 256×1×1 fails when only K=2 coding tensors are learned. Although, it is possible to reconstruct depths from a compressive histogram with as few as 2 coded projections, finding two coding tensors that can lead to an unambiguous depth range without further regularization can be challenging.

Overall, coding tensors that exploit spatial correlations are more robust to low SBR settings. However, at high SBR, operating in a large spatial neighborhood can make it harder to resolve fine scene details. Moreover, increasing the spatial block dimension further increases the number of parameters of the coding tensor which, as discussed in the Detailed Description, is less practical. In this analysis, it was found that coding tensors with spatial block of 2×2 and 4×4 achieve good balance of robustness to noise at low SBR, while being able to reconstruct fine scene details at high SBR.

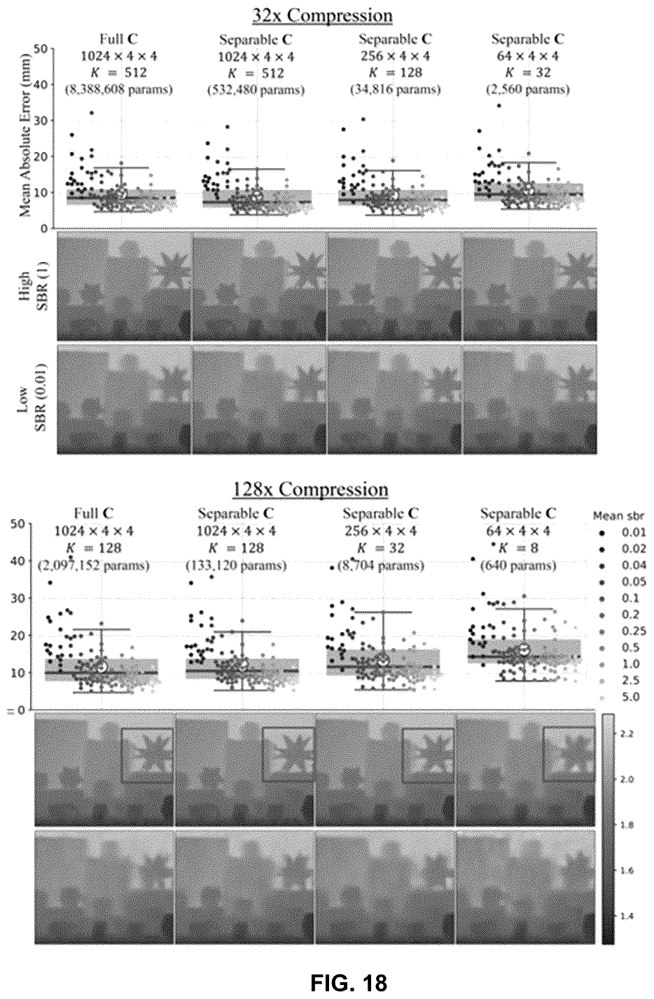

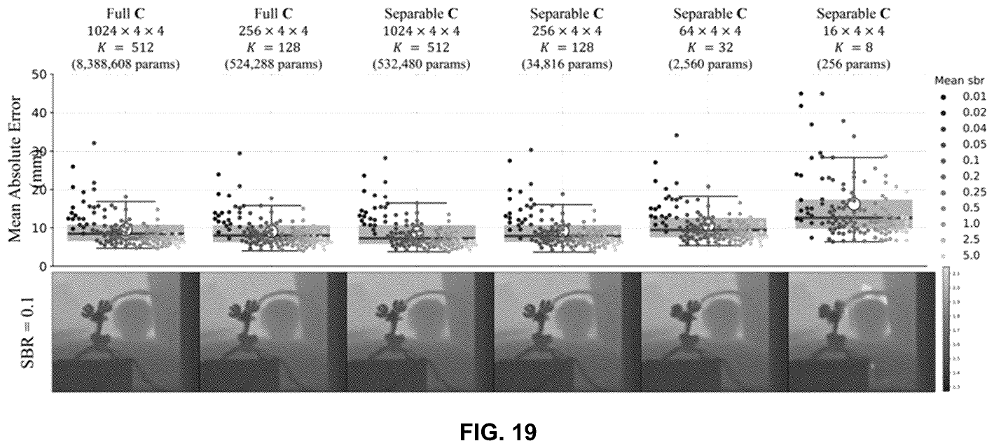

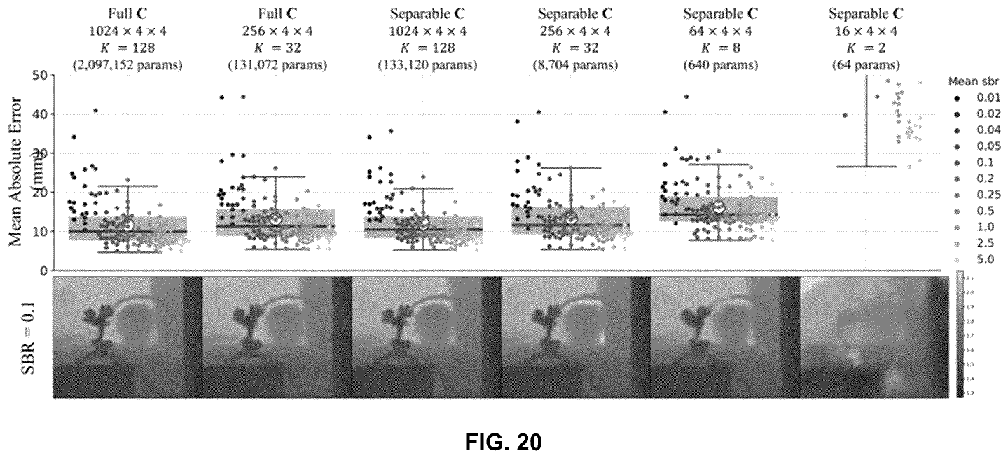

FIGS. 18, 19, and 20 show the quantitative and qualitative performance of different learned coding tensors as the number of parameters is reduced from left to right. In FIG. 18, each point in the scatter plots shows the MAE for a given test scene and their color hue represent the mean SBR used in that simulation. The horizontal black line, white circle, gray box, and error bars correspond to the median, mean, quartiles, and 1.5× the inter-quantile range, respectively. Outliers with an MAE larger than 50 mm are not visible in the plot, however, they are included in the calculation of the statistics. The images directly below each model correspond to the depth reconstructions for two test examples at low and high SBR levels whose mean signal and background photons per pixel are [10, 10] and [10, 1000], respectively. For a fixed compression level, the size of the coding tensors is reduced from left to right by making the coding tensors separable and also reducing the temporal dimension. All coding tensors are learned. In FIGS. 19 and 20, each scatter plot point corresponds to the MAE for each test scene. The depth images directly below each model correspond to the reconstruction of one test scene whose mean signal and background photons per pixel are [50, 500]. The size of the coding tensors is reduced from left to right by making the coding tensors separable and also reducing the temporal dimension.

The number of parameters is reduced by either making the coding tensors separable or making their temporal dimension smaller. At low compression levels (32× compression), coding tensors with as few as 2,560 parameters perform comparably to larger coding tensors with 100× more parameters. At higher compression levels (128× compression), the size of the coding tensors starts having a more pronounced effect on depth image quality. At higher SBR levels (i.e., SBR >0.1), the larger coding tensors are able to better recover fine scene structures such as the spikes in FIG. 3.2 or the toy reindeer antlers in 3.2. Nonetheless, coding tensors with as few as 8,704 parameters can continue to perform comparably to coding tensors with millions of parameters.

Learned vs. Fourier-based Temporal Compressive Representations: In this section, the performance of separable coding tensors whose Cₖ^{temporal} is either learned or fixed to a truncated Fourier coding tensor during training are compared.

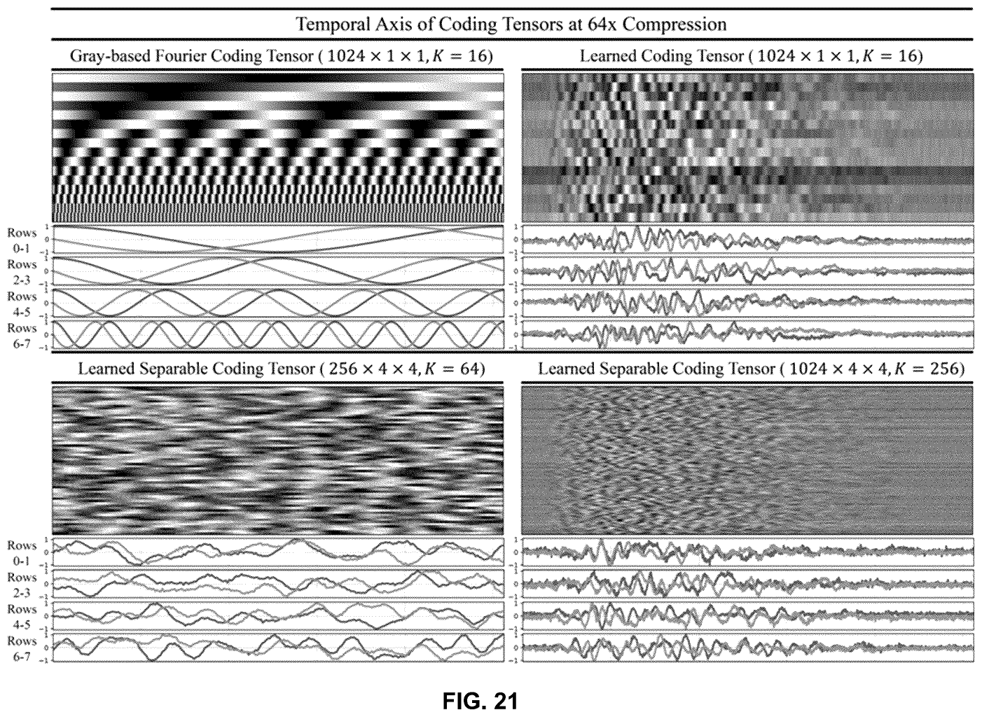

Temporal Gray Fourier: In addition to comparing with the Truncated Fourier coding tensors, performance was also compared to another Fourier-based coding tensor design, which is referred to herein as Gray Fourier. A Gray Fourier compressive histogram can use coding tensors with dimensions 1024×1×1. The coding tensors are a Fourier matrix where every two rows the frequency of the sinusoidal signal doubles as illustrated in FIG. 21. In FIG. 21, visualization of the temporal dimension for different coding tensors achieve 64× compression. The matrix visualized for coding tensors of dimension 1024×1×1 (columns 1 and 2) is an 16×1024 matrix, since K=16 and Mₜ=1024. On the other hand, the matrix for the learned separable 256×4×4ₖ is 64×256 since K=64 and Mₜ=256. Similarly, the matrix for the learned separable 1024×4×4ₖ is a 256×1024 matrix. Similar to techniques described herien and the in Detailed Description, this can be implemented as a compressive histogram layer, with fixed weights, whose outputs are processed by the depth estimation 3D CNN.

Fourier+Learned C: In this separable coding tensor design, the temporal coding tensors (Cₖ^{temporal}) were fixed to truncated Fourier coding tensors, and the spatial coding tensors (Cₖ^{spatial}) were learned. The temporal coding tensors in this design can be represented with a small number of parameters that do not scale with K discussed above hence, the in-sensor memory overhead they introduce is smaller than a fully learned coding tensor.

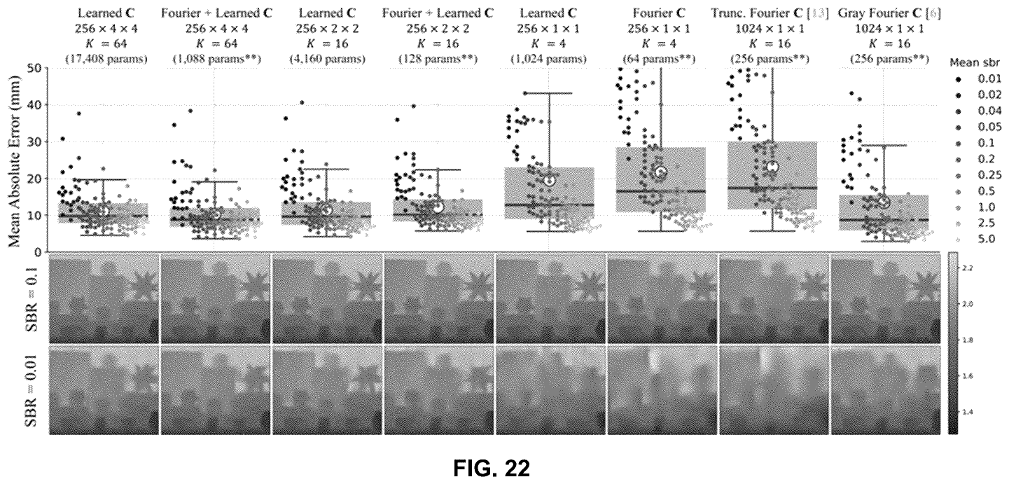

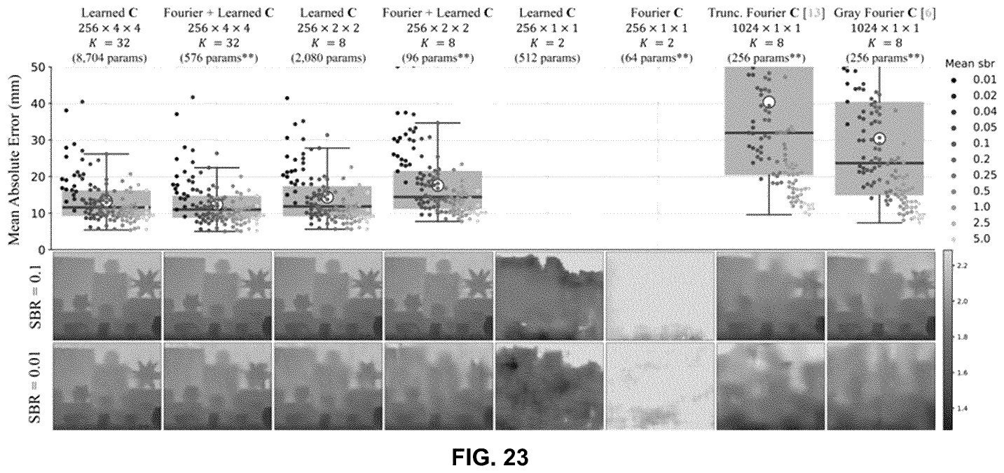

Results: FIGS. 22 and 23 show the overall test set performance and qualitative depth reconstructions for multiple compressive histogram models at 64× and 128× compression, respectively. In FIG. 22, each scatter plot point corresponds to the MAE for each test scene. The depth images directly below each model correspond to the reconstruction of one test scene whose mean signal and background photons per pixel are [50, 500] and [10, 1000]. All models use separable coding tensors. **The number of parameters for all coding tensors based on Fourier codes is calculated assuming the memory efficient representation described above. In FIG. 23, each scatter plot point corresponds to the MAE for each test scene. The depth images directly below each model correspond to the reconstruction of one test scene whose mean signal and background photons per pixel are [50, 500] and [10, 1000]. All models use separable coding tensors. The number of parameters for all coding tensors based on Fourier codes is calculated assuming the memory efficient representation described above. The models trained with 256×1×1 coding tensors at this compression level are not able to converge and are not able to learn how to reconstruct the scene. This is likely due to the fact that only K=2 coding tensors are used, which as discussed above, can make the optimization challenging.

As described in previous sections, coding tensors that exploit spatial information (e.g., 256×4×4 or 256×2×2) can be expected to provide higher quality reconstructions, especially, at lower SBR levels. At 64× compression (FIG. A11), models with Fourier or learned Cₖ^{temporal} perform comparably at all SBR levels. At 128× compression (FIG. A12), a fully learned coding tensor with dimensions 256×2×2 can provide some performance improvements for low SBR scenes over the Fourier+Learned 256×2×2 coding tensor. Nonetheless, at 128× compression, the 256×4×4 coding tensors provide the best performance.

Fourier-based temporal coding tensors have a memory-efficient implementation that does not scale with K. Using a flexible spatio-temporal compressive histogram framework described in the Detailed Description, coding tensors whose temporal dimension is fixed to Fourier codes and the spatial coding tensors are learned can be implemented. This results in a practical compressive histogram model that can be implemented in existing SPAD pixels while providing robust performance across SBR and compression levels. Fully learned coding tensors can still provide some improvements in the most challenging situations (high compression and low SBR), however, they require additional in-sensor memory. Nonetheless, this additional in-sensor memory may be negligible in implementations where a large number of SPAD pixels share the same copy of the coding tensors.

Evaluation on Real-world Data: To evaluate the generalization of the proposed models, raw histogram tensor data captured with a SPAD-based 3D camera prototype was downloaded. The dataset was captured with a line scanning system including a co-located picosecond laser and a 1D LinoSPAD array with 256 SPAD pixels. The histogram tensors have Nₜ=1536 time bins, a spatial resolution of 256×256, and a bin size Δ=26 ps. The raw histogram tensors were downsampled to be 1024×128×128 to make the time domain compatible with the learned coding tensors that use Mₜ=1024 and also to avoid out-of-memory errors.

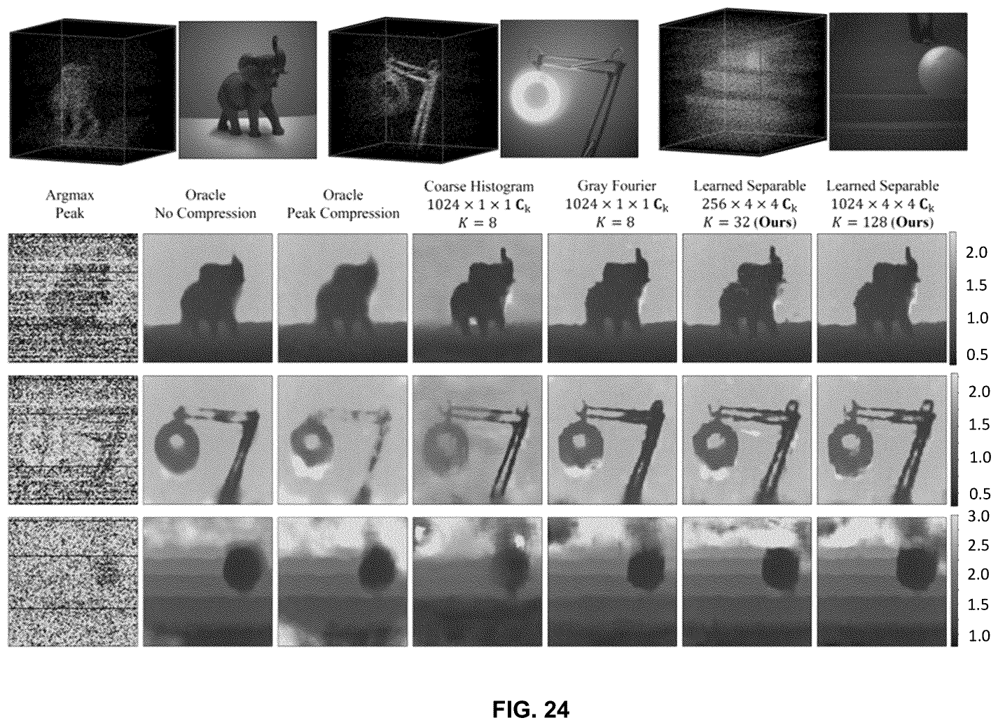

FIG. 24 shows the depth reconstructions for the oracle baselines and multiple compressive histograms at 128× compression. In FIG. 24, depth reconstructions of different scenes were captured with a SPAD-based 3D camera prototype. The first row shows a high-resolution intensity image of the captured scene and a point cloud visualization of the raw histogram tensor of that same scene.

All models were able to produce plausible depth reconstructions, suggesting good generalization to real-world data. However, all compressive histogram models display small artifacts throughout the image that could be due to high noise levels or generalization problems. These artifacts seem to be avoided by the oracle baselines (no compression and peak compression) by over-smoothing the images. This over-smoothing is due to the total variation regularizer that was used for the oracle baselines but not for the compressive histogram models, which was found to produce the better oracle models on the synthetic datasets. Therefore, these results suggest that a spatial regularizer can be used to improve compressive histogram model's generalization on real-world data. Nonetheless, despite these minor artifacts, the depth reconstructions suggest good generalization by all models to these challenging scenarios.

Comparison with Coarse Histogramming: Although, the depth images for the coarse histogramming coding tensor shown in FIG. 13 look reasonable qualitatively, they have large absolute depth errors when comparing them to the other approaches. A coarse histogram will often produce a quantized depth image, however, the depth estimation 3D CNN learned to smooth and upsample the coarse histogram and produce more plausible depth images. Nonetheless, coarse histograms consistently produce less accurate depth reconstructions than other compressive histogram approaches.

Comparison with Fourier-based C: It was observed that the model that use a Gray-based Fourier C at 128× compression produce blurrier depth reconstructions than the learned C models, This was observed in the lamp scene where the wires merge into a single blob, or in the staircase scene where the stair edges are blurred. On the other hand, the models with a learned C produce sharper depth reconstructions at the same compression level, despite being trained in the exact same manner.

Simulating SPAD Measurements: In this section, a detailed description of how SPAD measurements were simulated for the synthetic datasets used to generate results described herein and in the Detailed Description.

Given an RGB-D image, pulse waveform (h(t)), and the mean number of detected signal (Φₘₑₐₙ^{sig}) and background (Φₘₑₐₙ^{bkg}) photons per pixel, the photon detection parameters for EQ. (2) was set as follows. First, the amplitude of the illumination signal arriving at each pixel was calculated (aₚ in EQ. (1)) by using the reflectance at that pixel and accounting for the intensity radial fall-off due to distance. The NYUv2 training set reflectance was estimated using intrinsic image decomposition on the blue channel of the RGB image, and the Middlebury testing set reflectance was estimated using the mean of the RGB channels. Intrinsic image decomposition can lead to more accurate reflectance estimates for non-lambertian surfaces. Consequently, given aₚ, h (t), the per-pixel depths, and the average number of signal photon per pixel, the average number of signal photons arriving at each time bin can be scaled such that ΣₚΣᵢΦ_{i,p}^{sig}=Φₘₑₐₙ^{sig}. Similarly, the per-pixel background illumination (Φ^{bkg}) can be emulated using the RGB channel mean and scaling it such that it matches the desired mean number of background photons per pixel. Finally, dark counts can be added to the per-pixel background illumination component. This can be done on the training set using a calibration dark count image obtained from the hardware prototype in. It was observed that the models trained with this dark count component generalize well to histogram tensors without the dark counts, as shown in the test results.

Training and Implementation Details: In this section, further training and implementation details are described. All models used to generate results described herein and the in the Detailed Description were implemented in PyTorch. The input to all the models was a 3D histogram tensor. Recall that due to the linearity of compressive histograms, encoding the histogram tensors is equivalent to encoding each individual photon timestamp and summing them up. Hence, models deployed with a compressive histogram layer can also take as input a stream of photon timestamps and build the compressive histogram.

Compressive Histogram Layer: The compressive histogram layer was implemented as a single-layer encoder and decoder. The encoder was a 3D convolution with a stride equal to the filter size. The coding tensors, Cₖ, were the learned filters. All coding tensors were constrained to be zero-mean along the time dimension. This constraint makes the expected encoded value for background photons distributed uniformly along the time dimension be 0. The outputs of the encoder were the compressive histograms Ŷ_{b}. The decoder was an unfiltered backprojection that was implemented as a 3D transposed convolution with a stride equal to its filter size. To help the CNN model generalize to different photon count levels zero-normalization was applied along the channel dimension (K) to the inputs (Ŷ_{b}) and the weights (C) of the transposed convolution as follows:

$$ZN ( {\hat{Y}}_{b} ) = \frac{{\hat{Y}}_{b} - ( {\hat{Y}}_{b} )}{{‖ {\hat{Y}}_{b} - ( {\hat{Y}}_{b} ) ‖}_{2}} , \qquad ( 7 )$$

$$ZN ( C ) = \frac{C - ( C )}{{‖ C - ( C ) ‖}_{2}} ,$$

where the mean and L2 norm are computed over the channel dimension. This normalization is also known as layer normalization.

Depth Estimation 3D CNN Model: To estimate depths from the decoded histogram tensor, 3D deep boosting CNN model described in Peng et al., “Photon-efficient 3d imaging with a non-local neural network,” in European Conference on Computer Vision, pp. 225-241 (2020) was used for single-photon 3D imaging. Different from Peng et al., the implementation used to generate results described herein does not include a non-local block after the feature extraction stage. The output of the model was a denoised histogram tensor, H^{out}, from which depths were estimated using a softargmax function along the time dimension. The pixel-wise Kullback-Leibler (KL) divergence between the denoised histogram tensor and a normalized ground truth histogram tensor, H^{gt}, was used as an objective function. This loss can be written for each pixel, p, as:

$${L}_{KL} ( {H}_{p}^{gt} , {H}_{p}^{out} ) = {\sum }_{i = 0}^{{N}_{t} - 1} {H}_{i , p}^{gt} log ( \frac{{H}_{i , p}^{gt}}{{H}_{i , p}^{out}} ) \qquad ( 8 )$$

Training: At each training iteration, sample patches of size 1024×32×32 were randomly sampled from the training set. All models were trained using the ADAM optimizer with default parameters (β₁=0.9, β₂=0.999), batch size of 4, and an initial learning rate of 0.001 that decays by 0.9 after every epoch. All models were trained for 30 epochs with checkpoints every half an epoch, and for a given model the checkpoint that achieved the lowest root mean squared error (RMSE) on the validation set was chosen.

Analysis of the Memory Overhead of Coding Tensors: Compressive histograms have the potential to greatly reduce off-sensor data transmissions and the amount of in-sensor memory required compared to a conventional histogram tensor representation. However, the general compression framework described in the Detailed Description can include the in-sensor storage of the K coding tensors (C=(Cₖ)ₖ₌₀^{K-1}) that are used for compression. This means that a large C may introduce a significant amount of in-sensor memory overhead, making these designs for C less practical. In this section, a quantitative analysis of this memory overhead is described for different coding tensor designs.

Recall that H and C can be Nₜ×Nᵣ×N_{c} and K×Mₜ×Mᵣ×M_{c} tensors, respectively. Let, N=Nₜ·Nᵣ·N_{c} be the total number of elements in the histogram tensor. Moreover, let M=Mₜ·Mᵣ·M_{c} be the size of a single coding tensor which is also the size of the histogram block, H_{b} that is being compressed. For the remainder of this analysis, the following is assumed:

1. That all histogram blocks H_{b} that are compressed are non-overlapping. This means that the total number of compressive histograms that are transferred off-sensor is B=N/M.

2. That only a single C is stored inside the sensor. This C will be shared among all SPAD pixels.

3. That the elements of C and H are represented using the same number of bits.

Table 1 provides the expected compression ratios for off-sensor data transmission and in-sensor storage. These two compression ratios will differ due to the memory overhead incurred by compressive histograms when having to store the coding tensors. It is clear that a compressive histogram for a histogram block whose size equals the size of the histogram tensor (i.e., M=N), would actually require more in-sensor memory than the histogram tensor making this compressive histogram design impractical.

Table 1: Data Transmission and In-sensor Storage Requirements. This table shows the off-sensor data transmission and in-sensor storage requirements for a histogram tensor of size N and a set of B compressive histograms that use K coding tensors of size M for compression. The compression ratio column shows the amount of compression that can be achieved for off-sensor data transmission and in-sensor storage.

| | Histogram | Compressive | Compression |
|---|---|---|---|
| | Tensor | Histograms | Ratios |
| Off-sensor | N | B · K | N/(B · K) |
| Data | | | |
| Transmission | | | |
| In-sensor | N | (K · B) + | N/(K · (B + M)) |
| Storage | | (K · M) = | |
| | | K · (B + M) | |

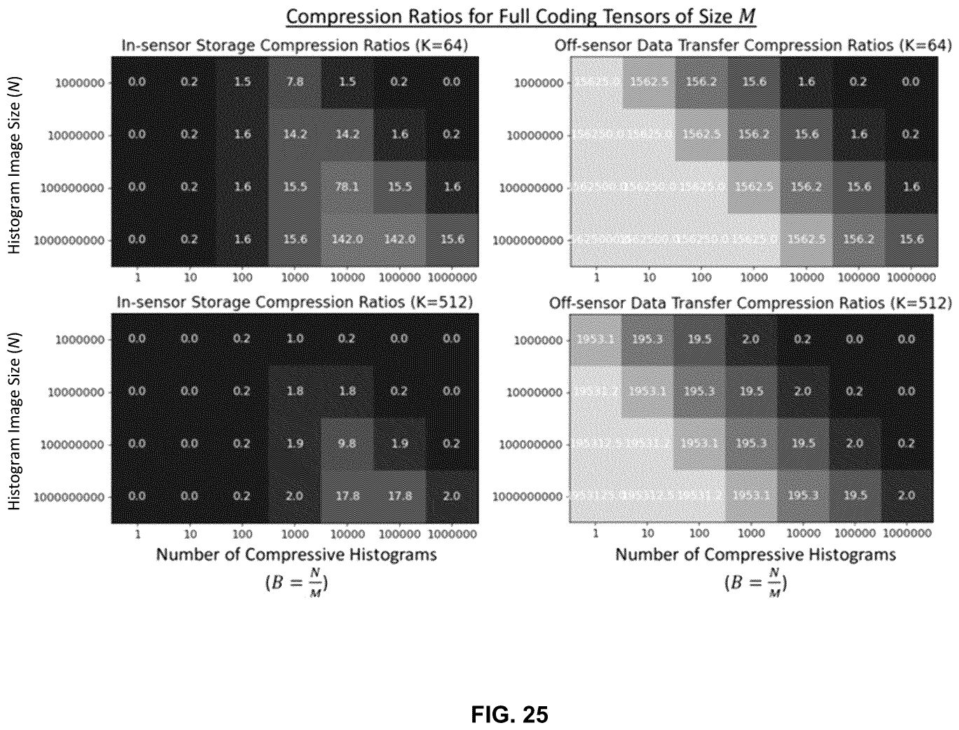

Compression Ratios for Full Coding Tensors: FIG. 25 shows the expected compression ratios for different histogram tensor and coding tensor sizes. In FIG. 25, each heatmap shows the compression ratio for a fixed K for different histogram tensor sizes (B) and number of compressive histograms (B) that are used. The compression ratios for in-sensor storage (left column) and data transfer (right column) are computed using the equations in Table 1.

As the number of compressive histograms are reduced to represent the histogram tensor, the size of the coding tensors will increase and consequently lower in-sensor compression is achieved. Since the coding tensors do not need to be transferred off-sensor, the data rate compression ratio continues to increase as the number of compressive histograms are reduced because the overall size of the compressive representation does decrease when K is fixed. Overall, a good balance between reducing in-sensor memory and data transmission seems to be achieved when using 10,000-100,000 compressive histograms to represent a histogram tensor with 1e9 element (e.g., a 1 megapixel SPAD array with 1000 bins per pixel). In this case, the size of a single coding tensor (M) should range between 10,000-100,000 for 64≤K≤512. Some of the coding tensors with K≥64 that were evaluated in this paper approximately match this size range, e.g., M=16,384 for 1024×4×4 or for 256×8×8.

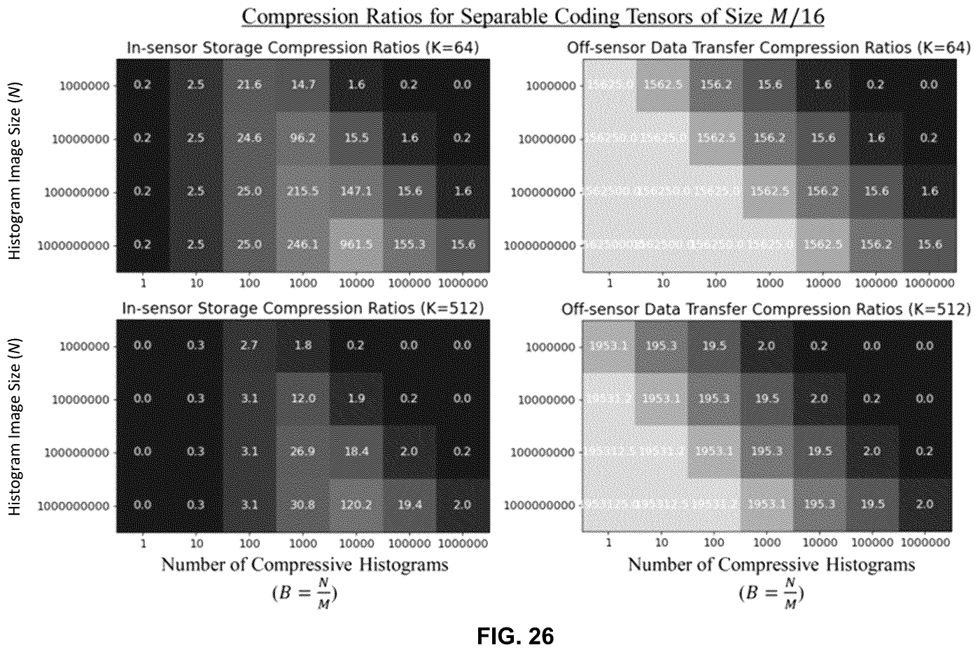

Compression Ratios for Separable Coding Tensors: FIG. 26 shows the expected compression ratios for different histogram tensor and coding tensor sizes for a separable coding tensor that is 16× smaller than a full coding tensor. In FIG. 26, each heatmap shows the compression ratio for a fixed K for different histogram tensor sizes (B) and number of compressive histograms (B) that are used. It is assumed that a separable coding tensor is 16× smaller than a full coding tensor, which is consistent with the separable coding tensors used in the Detailed Description. The compression ratios for in-sensor storage and data transfer are computed using the equations in Table 1 replacing M with M/16.

A separable coding tensor that is ˜16× smaller is consistent with the separable coding tensors used in the main paper. For instance, a 256×4×4 Cₖ is ˜16× smaller if its temporal and spatial dimensions are separable. In this scenario, a good balance between in-sensor storage and data transmission compression can be achieved when using 1,000-100,000 compressive histograms to represent a histogram tensor with 1e9 elements. In this case, the size of a single separable coding tensor should range between 625-62,500 for 64≤K≤512. Some of the separable coding tensors with K≥64 that were evaluated in this paper approximately match this size range: M=272 (256×4×4), M=1040 (1024×4×4).

Parameter-efficient coding tensors can reduce the in-sensor memory overhead that compressive histograms introduce. In this section, it was shown that the local block-based separable coding tensor designs explored in this paper are able to reduce the memory overhead for histogram tensors of size N≥1e7 Additional lightweight C designs can rely on other factorization techniques such as low-rank approximations. In some examples, weight quantization can be an effective technique in further compressing C. Finally, designs with parameters that can be computed on the fly, such as Fourier-based (Sec. A2) or Gray codes, are a practical design when multiple C need to be stored across the SPAD array. Ultimately, a practical coding tensor representation can be determined by the hardware constraints of a given SPAD camera.

### Further Examples Having a Variety of Features:

Implementation examples are described in the following numbered claims.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term mechanism can encompass hardware, software, firmware, or any suitable combination thereof.

It should be understood that the above described steps of the process of FIG. 6 can be executed or performed in any order or sequence not limited to the order and sequence shown and described in the figures. Also, some of the above steps of the processes of FIG. 6 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for determining a depth in a scene, comprising:
a light source;
an array comprising a plurality of detectors configured to detect arrival of individual photons;
at least one processor that is programmed to:
(a) detect, based on a signal from a detector of the plurality of detectors, a photon arrival,
wherein the detector of the plurality of detectors has a position p′;
(b) determine a time bin i associated with the photon arrival, wherein the time bin is in a range from 1 to Nₜ where Nₜ is a total number of time bins;
(c) update a compressed histogram comprising K stored values representing bins of the compressed histogram based on K values in a code word calculated based on the time bin i and the position p′ and K coding tensors,
wherein each coding tensor of the K coding tensors is different than each other coding tensor; and
(d) perform an imaging task based on the K values of the compressed histogram.

2. The system of claim 1, wherein each of the plurality of detectors comprises a single photon avalanche diode (SPAD).

3. The system of claim 1, wherein each of the coding tensors has a size Mₜ×Mᵣ×M_{c}, and wherein the at least one processor is further programmed to:
estimate depth values for Mᵣ×M_{c} detectors using the K values of the compressed histogram.

4. The system of claim 1, wherein (a) to (c) are performed by circuitry that is implemented on a same chip as the plurality of detectors.

5. The system of claim 4, wherein (d) is performed by circuitry that is implemented on a different chip than the plurality of detectors.

6. The system of claim 1, wherein the at least one processor is further programmed to:
perform a dot product operation between a one-hot matrix and the K coding tensors,
wherein the one-hot matrix has a 1 at a position corresponding to position i,p′ within a block b of positions having a size Mₜ×Mᵣ×M_{c}, where i is the time bin i and p′ is a position;
transfer the K values of the compressed histogram from a chip on which the plurality of detectors are implemented to a second chip; and
perform an unfiltered backprojection of the K values of the compressed histogram using the K coding tensors, thereby generating an Mₜ×Mᵣ×M_{c} matrix of values,
wherein to perform the imaging task, the at least one processor is programmed to:
estimate a depth value for the detector based on the Mᵣ×M_{c} matrix of values.

7. The system of claim 1, wherein the K coding tensors change over time based on the scene.

8. The system of claim 6, wherein to perform the convolution between the one-hot matrix and the K coding tensors, the at least one processor is programmed to: perform a lookup based on each dot product of the convolution, wherein the one-hot matrix comprises a single element having a 1.

9. The system of claim 6, wherein the at least one processor is further programmed to:
estimate the depth value for the detector based on the Mₜ×Mᵣ×M_{c} matrix of values using a convolutional neural network (CNN),
wherein a first layer of the CNN comprises the convolution between the one-hot matrix and the K coding tensors, and other layers of the CNN are trained to determine depth values from an Nₜ×Nᵣ×N_{c} matrix of values,
wherein Nₜ×Nᵣ×N_{c} comprises a plurality of matrices each having a size of Mₜ×Mᵣ×M_{c}.

10. The system of claim 9, wherein at least some of the weights of the K coding tensors were trained using a CNN training process.

11. The system of claim 1, wherein the at least one processor is further programmed to:
perform (a) to (d) for each of the plurality of detectors.

12. The system of claim 1, wherein Mₜ is less than or equal to Nₜ.

13. The system of claim 1, wherein each of the K coding tensors is expressible as an outer product of two tensors Cₖ^{temporal}, and Cₖ^{spatial}, where Cₖ^{temporal} is a Mₜ×1×1 tensor, and Cₖ^{spatial} is a 1×Mᵣ×M_{c} tensor.

14. A method for determining a depth in a scene, comprising:
(a) detecting, based on a signal from a detector of a plurality of detectors, a photon arrival,
wherein the detector of the plurality of detectors has a position p′;
(b) determining a time bin i associated with the photon arrival, wherein the time bin is in a range from 1 to Nₜ where Nₜ is a total number of time bins;
(c) updating a compressed histogram comprising K stored values representing bins of the compressed histogram based on K values in a code word calculated based on the time bin i and the position p′ and K coding tensors,
wherein each coding tensor of the K coding tensors is different than each other coding tensor; and
(d) performing an imaging task based on the K values of the compressed histogram.

15. The method of claim 14, wherein each of the plurality of detectors comprises a single photon avalanche diode (SPAD).

16. The method of claim 14, wherein each of the coding tensors has a size Mₜ×Mᵣ×M_{c}, the method further comprising:
estimating depth values for Mᵣ×M_{c} detectors using the K values of the compressed histogram.

17. The method of claim 14, further comprising:
performing a convolution between a one-hot matrix and the K coding tensors,
wherein the one-hot matrix has a 1 at a position corresponding to position i,p′ within a block b of positions having a size Mₜ×Mᵣ×M_{c}, where i is the time bin i and p′ is a position;
transferring the K values of the compressed histogram from a chip on which the plurality of detectors are implemented to a second chip;
performing, using a processor implemented on the second chip, an unfiltered backprojection of the K values of the compressed histogram using the K coding tensors, thereby generating an Mₜ×Mᵣ×M_{c} matrix of values; and
estimating the depth value for the detector based on the Mₜ×Mᵣ×M_{c} matrix of values.

18. The method of claim 14, wherein each of the K coding tensors is expressible as an outer product of two tensors Cₖ^{temporal}, and Cₖ^{spatial}, where Cₖ^{temporal} is a Mₜ×1×1 tensor, and Cₖ^{spatial} is a 1×Mᵣ×M_{c} tensor.

19. A system for generating compressed single-photon histograms, comprising:
a light source;
an array comprising a plurality of detectors configured to detect arrival of individual photons;
at least one processor that is programmed to:
(a) detect, based on a signal from a detector of the plurality of detectors, a photon arrival,
wherein the detector of the plurality of detectors has a position p′;
(b) determine a time bin i associated with the photon arrival, wherein the time bin is in a range from 1 to Nₜ where Nₜ is a total number of time bins;
(c) update a compressed histogram comprising K stored values representing bins of the compressed histogram based on K values in a code word calculated based on the time bin i and the position p′ and K coding tensors,
wherein each coding tensor of the K coding tensors is different than each other coding tensor; and
(d) output the compressed histogram to another processor.

20. The system of claim 18, wherein each of the coding tensors has a size Mₜ×Mᵣ×M_{c}, and wherein the at least one processor is further programmed to perform at least one of the following:
estimate depth values for Mᵣ×M_{c} detectors using the K values of the compressed histogram;
perform a 3D object detection for an object of a scene represented in the signal from the plurality of detectors;
perform a 3D image segmentation operation for an image of the scene represented in the signal from the plurality of detectors; or
perform a 3D object tracking for the object of the scene represented in the signal from the plurality of detectors.

21. The system of claim 18, wherein the at least one processor is further programmed to:
perform a convolution between a one-hot matrix and the K coding tensors,
wherein the one-hot matrix has a 1 at a position corresponding to position i,p′ within a block b of positions having a size Mₜ×Mᵣ×M_{c}, where i is the time bin i and p′ is a position.
